(19) United States
(12) Patent Application Publication
(10) Pub. No.: US 2011/0233468 A1
(43) Pub. Date: Sep. 29, 2011

(54) PROCESS OF FORMING A CADMIUM AND SELENIUM CONTAINING NANOCRYSTALLINE COMPOSITE AND NANOCRYSTALLINE COMPOSITE OBTAINED THEREFROM

(75) Inventors: Yun Zong, Singapore (SG); Mingyong Han, Singapore (SG); Wolfgang Knoll, Singapore (SG)

(73) Assignee: AGENCY FOR SCIENCE, TECHNOLOGY AND RESEARCH, Singapore (SG)

(21) Appl. No.: 12/672,269

(22) PCT Filed: Aug. 6, 2008
(86) PCT No.: PCT/SG08/00290

§ 371 Date: Jun. 15, 2011

Related U.S. Application Data
(60) Provisional application No. 60/954,179, filed on Aug. 6, 2007.

(51) Int. Cl. C09K 11/54; B82Y 20/00

(52) U.S. Cl. 252/301.6 R; 977/774

(57) ABSTRACT

Provided is a process of forming a Cd and Se containing nanocrystalline composite. The nanocrystalline composite has a composition of one of (a) Cd, M, Se, (b) Cd, Se, A, and (c) Cd, M, Se, A, with M being an element of group (12) of the PSE other than Cd and A being an element of group (16) of the PSE other than O and Se. In one embodiment in a suitable solvent a solution of the element Cd, or a precursor thereof, and, where applicable, of M, or a precursor thereof is formed. To the solution the element Se and, where applicable, A is added and thereby a reaction mixture formed. The reaction mixture is heated for a sufficient period of time at a temperature suitable for forming the Cd and Se containing nanocrystalline composite and then the reaction mixture is allowed to cool. Finally the Cd and Se containing nanocrystalline composite isolated. In another embodiment the reaction mixture is formed by adding into a suitable solvent the element Cd, or a precursor thereof, Se, where applicable M and where applicable A. In this embodiment the reaction mixture is heated and water formed during the process is being removed.

This application makes reference to and claims the benefit of priority of an application for “Visible Light Excitable Nanocrystals and Methods of Preparing Them” filed on Aug. 6, 2007 with the United States Patent and Trademark Office, and there duly assigned Ser. No. 60/541,179. The contents of said application filed on Aug. 6, 2007 is incorporated herein by reference for all purposes, including an incorporation of any element or part of the description, claims or drawings not contained herein and referred to in Rule 20.5(a) of the PCT, pursuant to Rule 4.18 of the PCT.

The present invention relates to a process of forming a Cd and Se containing nanocrystalline composite.

Inorganic nanoparticles find a wide range of applications including e.g. as coloring agents (e.g. in stained glass windows), catalysts, as magnetic drug delivery, hypothermic cancer therapy, contrast agents in magnetic resonance imaging, magnetic and fluorescent tags in biology, solar photovoltaics, nano bar codes or emission control in diesel vehicles.

Semiconductor nanoparticles, typically nanocrystals, that confine the motion of conduction band electrons, valence band holes, or excitons (in all three spatial directions) can serve as “droplets” of electric charge and are termed quantum dots. Quantum dots can be as small as 2 to 10 nanometers, with self-assembled quantum dots typically ranging between 10 and 50 nanometers in size.

Quantum dots have attracted interest for various uses, including electronics, fluorescence imaging and optical coding. They are of particular importance for optical applications due to their theoretically high quantum yield. In electronic applications they have been proven to operate like a single-electron transistor and show the Coulomb blockade effect.

Water-soluble quantum dots with high quantum yield have been one of the focuses in fluorescent label based biological research. The earliest available quantum dots for this purpose were prepared from quantum dots with a semiconductor core and an organic ligand shell (CdSe was the representative). One used thioglycolic acid complying with a complicated ligand exchange process in the presence of different stabilizing agents, or made use of hydrophobic-hydrophobic interaction to coat the as-prepared oil-soluble quantum dots with amphiphilic molecules/polymers, or encapsulated quantum dots with a silica shell, to realize water-solubilisation. Regardless of the complexity of these approaches, the quantum yield of the resulting quantum dots was low. This, on one hand, was the inheritance of the low quantum yield of the CdSe core-quantum dots; on the other hand, thanks to the poorly passivated semiconductor surface, the emitting center, which is easily damaged during the process, further lowers the quantum yield. Alloy quantum dots have high quantum yield; however, their fragile surface is a problem in water-solubilisation.

With the introduction of the core-shell structure for quantum dots by adding an additional layer of passivating semi-conducting materials between the emitting core and the ligand layer, the optical property of the quantum dots is greatly improved (M. A. Hines, & P. Guyot-Sionnest. J. Phys. Chem. 1996, 100, 468; B. O. Dabbousi, et al., J. Phys. Chem. B 1997, 101, 9463; X. Peng, et al., J. Am. Chem. Soc. 1997, 119, 7019 16-18). Meanwhile, the water-solubilisation process for these core-shell quantum dots is simpler, and the resulting products are less fragile (S. Kim, et al. J. Am. Chem. Soc. 2003, 125, 11466; D. R. Larson, et al., Science 2003, 300, 1434; J. K. Jaiswal, et al., Nat. Biotech. 2003, 21, 47). The preparation of core-shell quantum dots has two basic steps: (1) preparation and purification of core quantum dots with high quality; (2) coating the core-quantum dots using an organometallic agent and another VIA source (e.g., S or Se) following a Successive Ion Layer Adsorption and Reaction (SILAR) growth strategy (Peng, et al., 1997, supra). The 2^{nd} step in the preparation is crucial on the quality of the final products; however, it is exhausting and difficult to control (especially if large amount of products are desired).

It is therefore an object of the present invention to provide a method or process that can be used to form a nanocrystalline composite, in particular a nanoparticle that overcomes at least some of the above explained difficulties.

In one aspect the present invention provides a process of forming a Cd and Se containing nanocrystalline composite.

In one embodiment of the first aspect the Cd and Se containing nanocrystalline composite is composed of the elements Cd, M, and Se. M is an element of group 12 of the PSE other than Cd. In this embodiment the process includes forming in a suitable solvent a solution of the element Cd or a Cd precursor, and of M, or a precursor thereof. Further, the process includes adding to the solution the element Se. Thereby a reaction mixture is formed. The process also includes heating the reaction mixture for a sufficient period of time at a temperature that is suitable for forming the Cd and Se containing nanocrystalline composite. The process further includes thereafter allowing the reaction mixture to cool. The process also includes isolating the Cd and Se containing nanocrystalline composite.

In another embodiment of the first aspect the Cd and Se containing nanocrystalline composite is composed of the elements Cd, M, Se and A. M is an element of group 12 of the PSE other than Cd. A is an element of group 16 of the PSE other than O and Se. In this embodiment the process includes forming in a suitable solvent a solution of the element Cd or a Cd precursor, and of M, or a precursor thereof Further, the process includes adding to the solution the element Se. The process also includes adding A to the solution. By adding A and Se to the solution a reaction mixture is formed. The process further includes heating the reaction mixture for a sufficient period of time at a temperature that is suitable for forming the Cd and Se containing nanocrystalline composite. The process further includes thereafter allowing the reaction mixture to cool. The process also includes isolating the Cd and Se containing nanocrystalline composite.

In another embodiment of the first aspect the Cd and Se containing nanocrystalline composite is composed of the elements Cd, Se and A. A is an element of group 16 of the PSE other than O and Se. In this embodiment the process includes forming in a suitable solvent a solution of the element Cd or a Cd precursor. Typically the solvent is at least essentially amine free. Further, the process includes adding to the solution the element Se. The process also includes adding A to the solution. By adding A and Se to the solution a reaction mixture is formed. The process further includes heating the reaction mixture for a sufficient period of time at a temperature that is suitable for forming the Cd and Se containing nanocrystalline composite. The process further includes thereafter allowing the reaction mixture to cool. The process also includes isolating the Cd and Se containing nanocrystalline composite.

In a related second aspect the present invention provides a process of forming a nanocrystal of the composition of one of: (a) Cd, M, Se, (b) Cd, Se, A, and (c) Cd, M, Se, A. M is an element of group 12 of the PSE other than Cd. A is an element of group 16 of the PSE other than O and Se. The process includes adding into a suitable solvent the element Cd or a Cd precursor. The process also includes adding into the solvent the element Se. In the formation of a nanocrystalline composite having a composition of (a) Cd, M, Se, or (c) Cd, M, Se, A, the process also includes adding M, or a precursor thereof In the formation of a nanocrystalline composite having a composition of (b) Cd, Se, A, or (c) Cd, M, Se, A, the process also includes adding A. By adding the respective compounds to the solvent a reaction mixture is formed. Further, the process includes heating the reaction mixture for a sufficient period of time at a temperature that is suitable for forming the Cd and Se containing nanocrystalline composite. Heating the reaction mixture further includes removing water formed in the reaction mixture. The process further includes thereafter allowing the reaction mixture to cool. The process also includes isolating the Cd and Se containing nanocrystalline composite.

The nanocrystal obtained by a process of the invention is a composite in that it is non-homogenous. In typical embodiments the nanocrystal is core-shelled.

In a third aspect the invention relates to a Cd and Se containing nanocrystalline composite. The nanocrystalline composite has a composition of one of (a) Cd, M, Se, (b) Cd, Se, A, and (c) Cd, M, Se, A. M is an element of group 12 of the PSE other than Cd, and A is an element of group 16 of the PSE other than O and Se. The nanocrystalline composite is obtainable, including obtained, by a process according to the first or the second aspect.

In a fourth aspect the invention also relates to the use of a nanocrystal obtained by one of the above processes in the manufacture of an illuminant.

The invention will be better understood with reference to the detailed description when considered in conjunction with the accompanying drawings, in which:

FIG. 1A shows schematically the structure of a core quantum dot, e.g. CdSe, CdS, CdTe, ZnS, ZnSe, ZnTe, PbS, PbSe, ZnO, etc. FIG. 1B shows schematically the structure of a core-shell quantum dot, e.g. CdSe/ZnS, CdTe/ZnS, CdSe/ZnSe etc. FIG. 1C shows schematically the structure of an alloy quantum dot, e.g. CdSeₓTe₁₋ₓ, ZnₓCd₁₋ₓSe, ZnₓCd₁₋ₓS, CdSₓSe₁₋ₓ, etc.

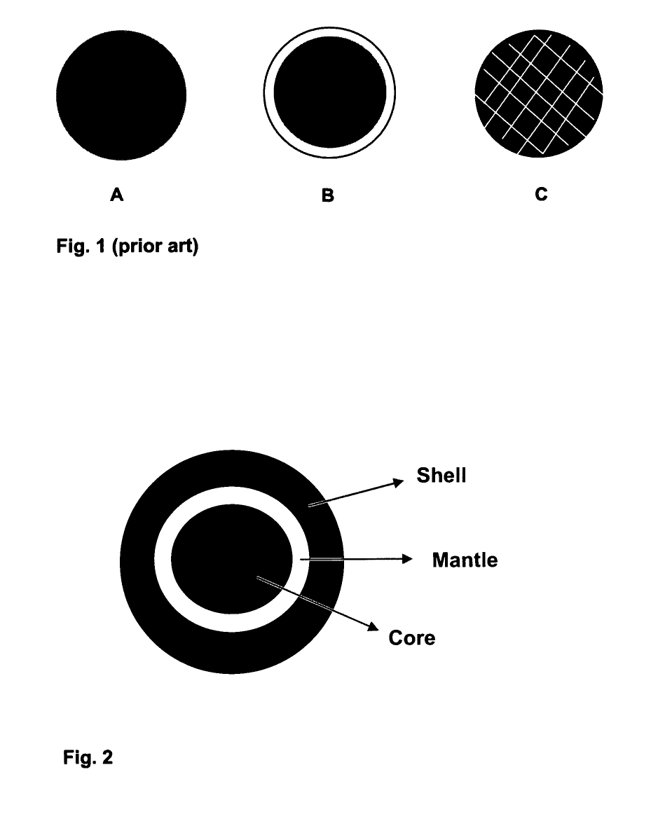

FIG. 2 depicts schematically a nanocrystalline composite material obtained herein which can be described as a nanocrystal/quantum dot with a core-mantle-shell structure. In one embodiment the core may for instance be composed of CdSe, whereas the mantle may be composed of CdZnSe and the shell may be composed of ZnSe. In another embodiment the core may for instance be composed of CdSe, while the mantle may be composed of CdSeS and the shell may be composed of CdS.

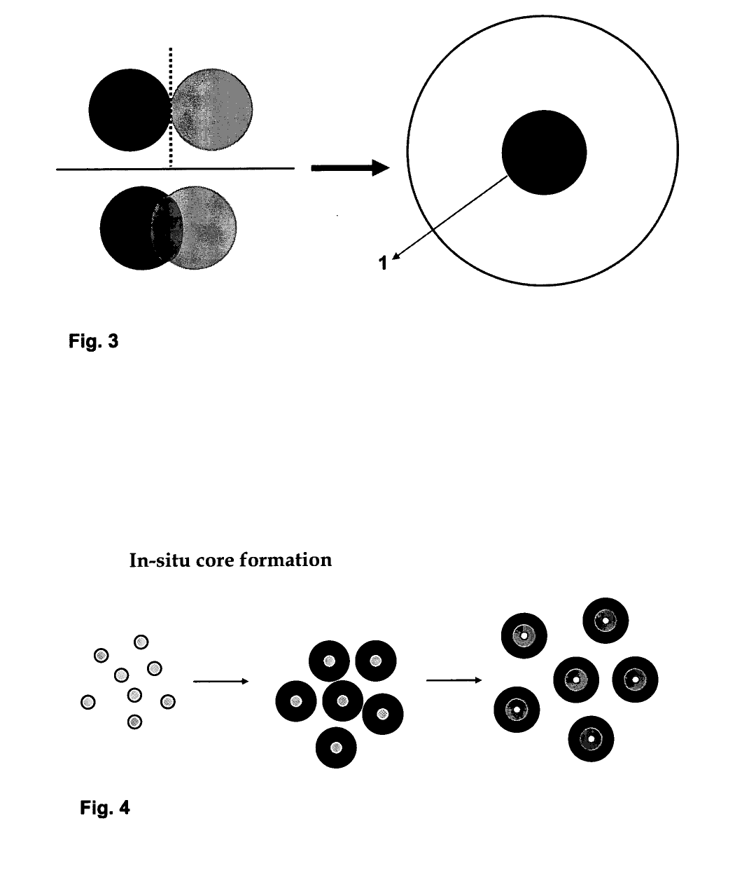

FIG. 3 depicts a possible explanation on an effect that prevents dislocation of the shell of a nanocrystalline composite according to the invention at high thickness: A lattice mismatch may be the cause of a phase separation (left part of FIG. 3). Partially alloying at the interface of core and shell may occur (T control). A mantle may thus be figured as serving as a layer of glue between core and shell.

FIG. 4 depicts the expected progress of the reaction as a dynamic, controlled reaction. The core is formed in-situ and since a one-step operation is performed, there is no need of successive and alternate injection.

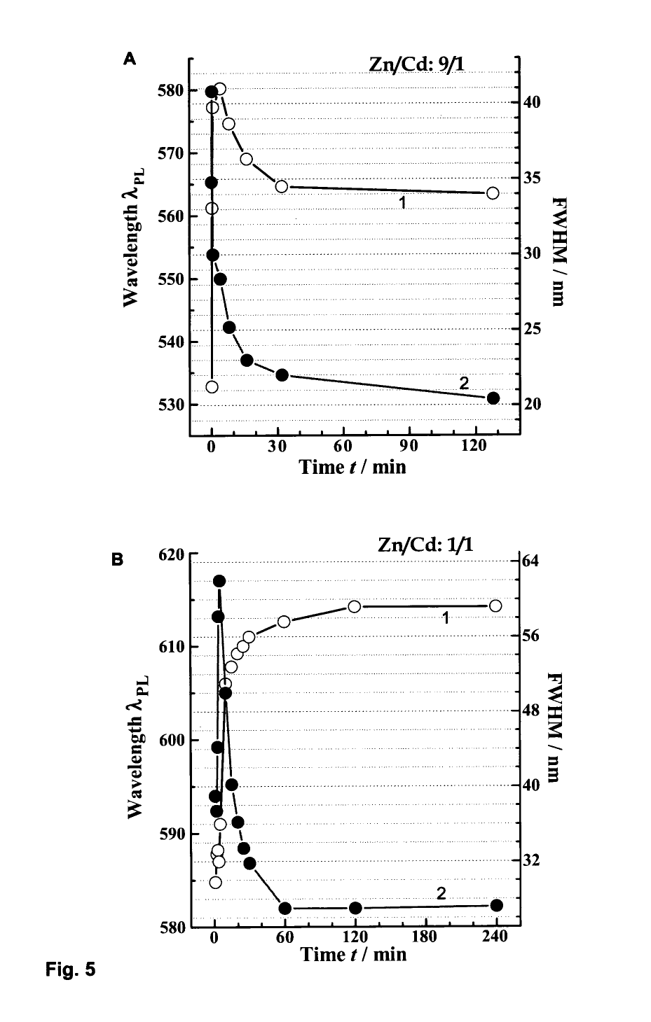

FIG. 5 depicts the progress of the formation of two room-light excitable quantum dots with a molar ratio of Zn:Cd in the starting materials as: (A) 9:1; (B) 1:1, shown by the time course of photoluminescence spectra. The curves labelled “1” show the wavelengths (left ordinate), and the curves labelled “2” show the full width at half maximum of the spectra (right ordinate).

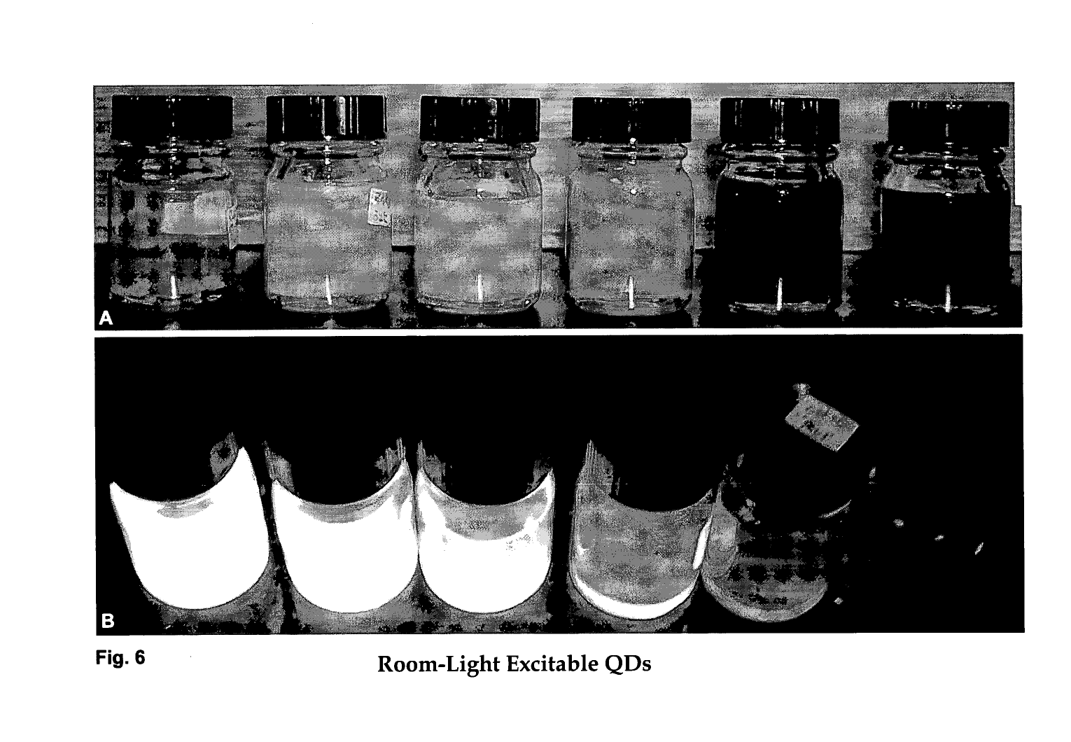

FIG. 6 depicts a photo on room-light excitable quantum dots obtained by a process according to the invention. A: the quantum dots in weak room light; B: the quantum dots under UV irradiation. In both cases the flash of the camera was off.

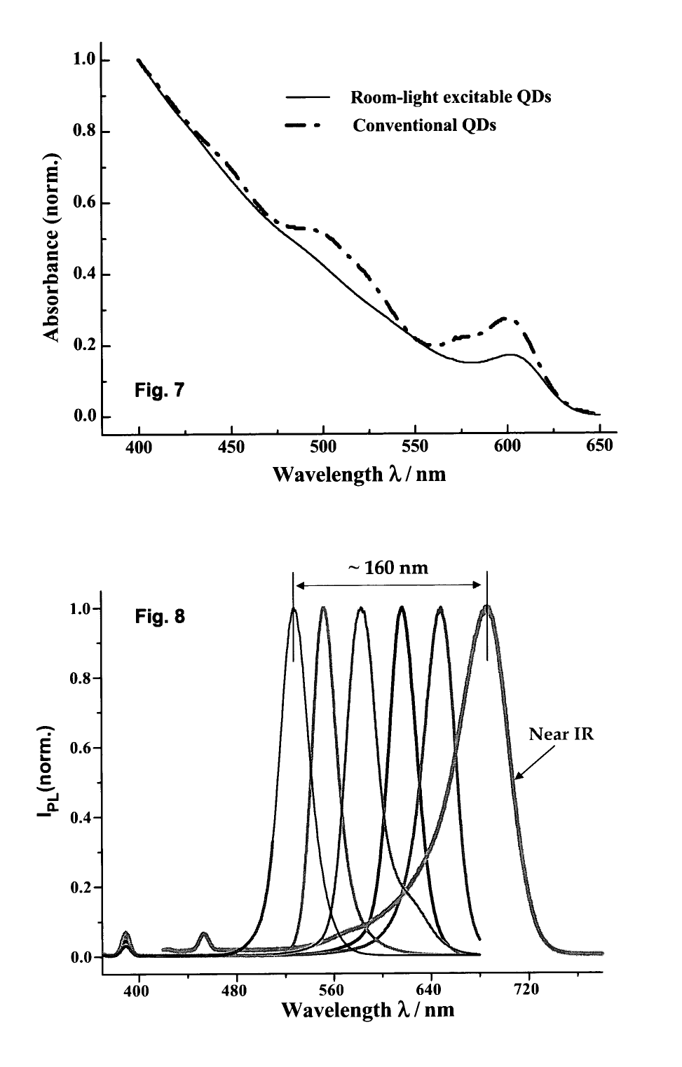

FIG. 7 depicts UV-visible spectra of one of the room-light excitable quantum dots (thin solid line) and conventional quantum dots (thick broken line). Absorption of the former in the visible light wavelength range is weaker.

FIG. 8 depicts photoluminescence spectra of some room-light excitable Cd+Zn+Se composite quantum dots. From left to right the amount of the zinc in the quantum dots decreases steadily, with the emission shifting from 528 nm to 689 nm.

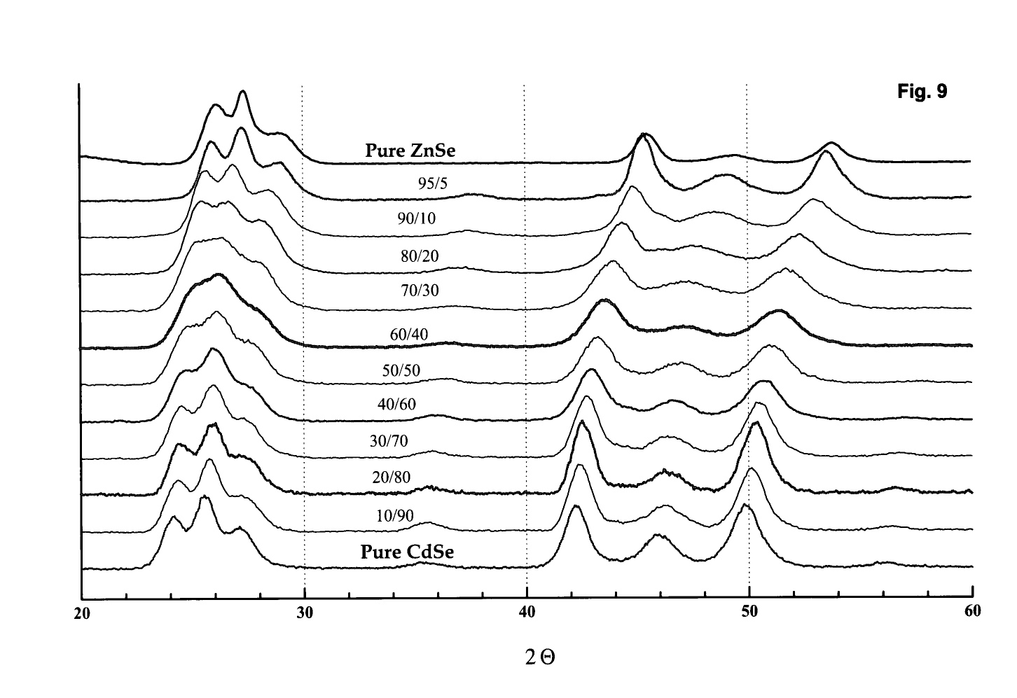

FIG. 9 depicts X-ray diffraction patterns for different room-light excitable nanocrystalline compositive material (quantum dots) of the composition Cd+Zn+Se (predicted structure CdSe/CdₓZn₁₋ₓSe/ZnSe). The numbers above each figure denote the Zn/Cd molar ratios in the starting materials for the preparation of the corresponding quantum dots. The topmost and the bottommost data are the XRD patterns for pure ZnSe and CdSe quantum dots, respectively.

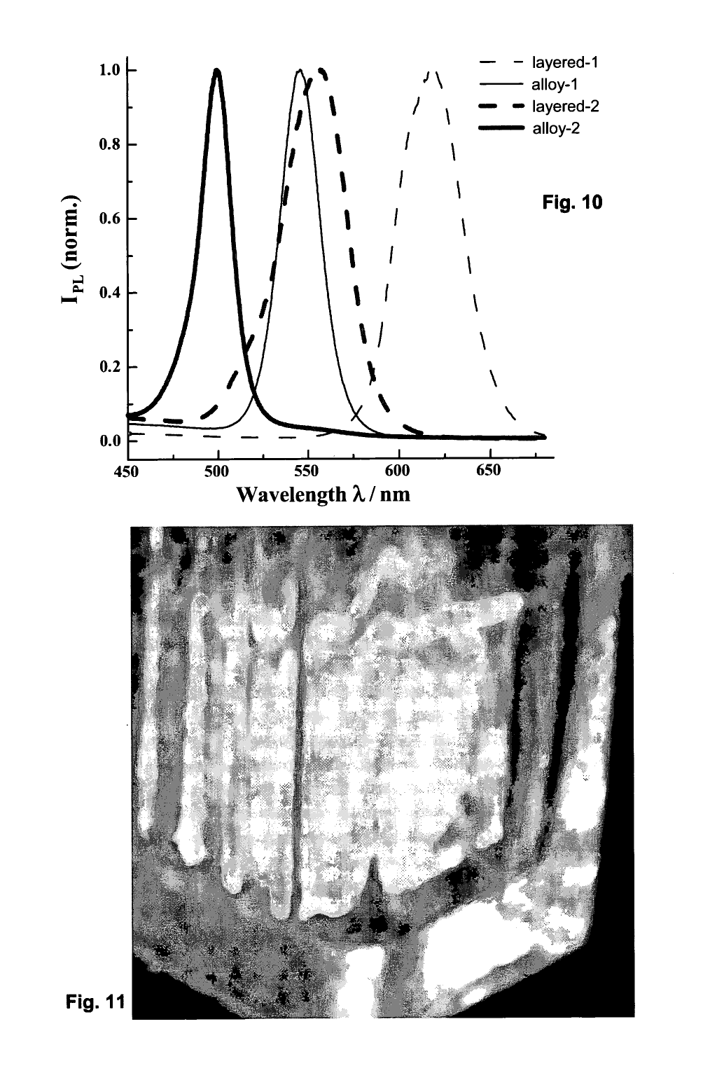

FIG. 10 shows photoluminescence spectra of room-light excitable quantum dots prepared in TOPO/HDA at 300° C. (broken lines) and their alloy counterparts (solid lines) formed by heating the same room-light excitable quantum dots to sufficiently higher temperatures. The molar ratio for Zn/Cd in the starting materials is 1:1 or 9:1 for the quantum dots with the thin (“1”) or the thick (“2”) line spectra, respectively.

FIG. 11 depicts polymer/quantum dots hybrid thin films (room-light excitable quantum dots in poly(methyl methacrylate)), obtained via spincoating.

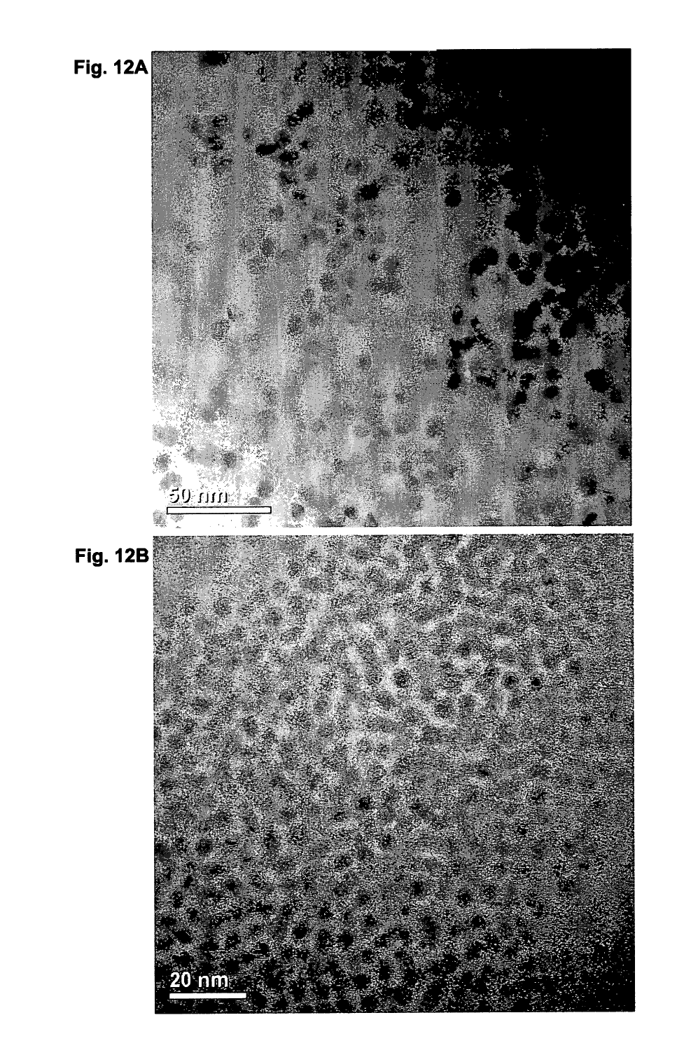

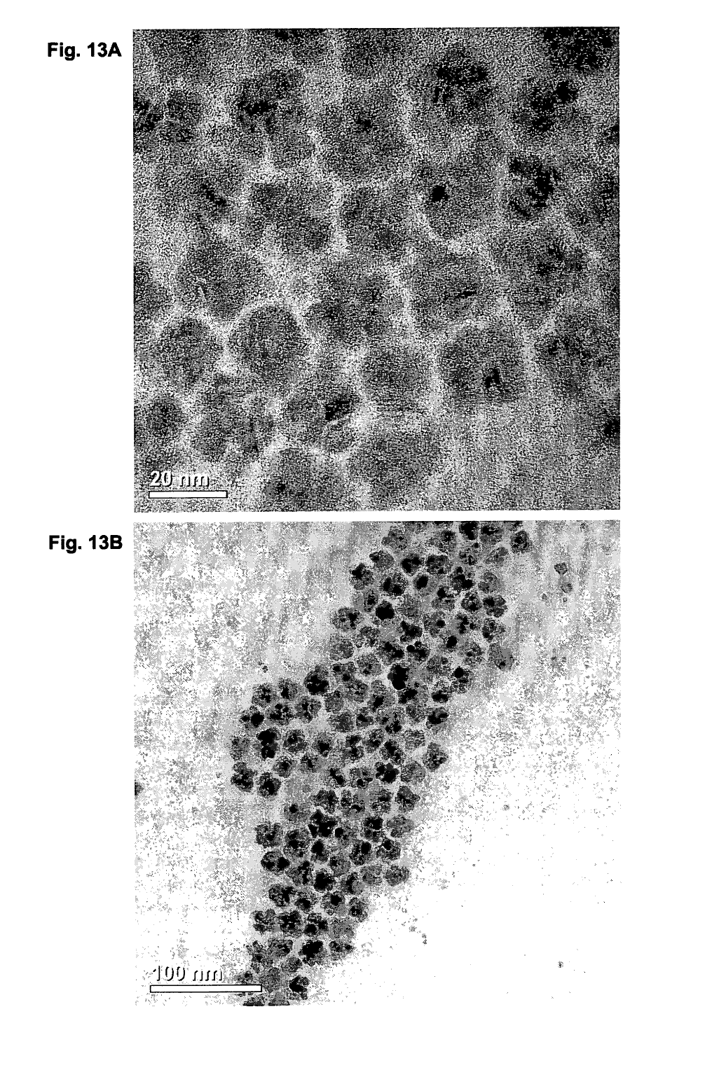

FIG. 12 depicts transmission electron microscope images of room-light excitable quantum dots. A: Cd+Zn+Se (predicted structure CdSe/CdₓZn₁₋ₓSe/ZnSe); B: Cd+Se+S (predicted structure CdSe/CdSeₓS₁₋ₓ/CdS).

FIG. 13 depicts transmission electron microscope images of 4-component room-light excitable nanocrystals being composed of Zn+Cd+Se+S. The two images (A) and (B) are in different magnifications.

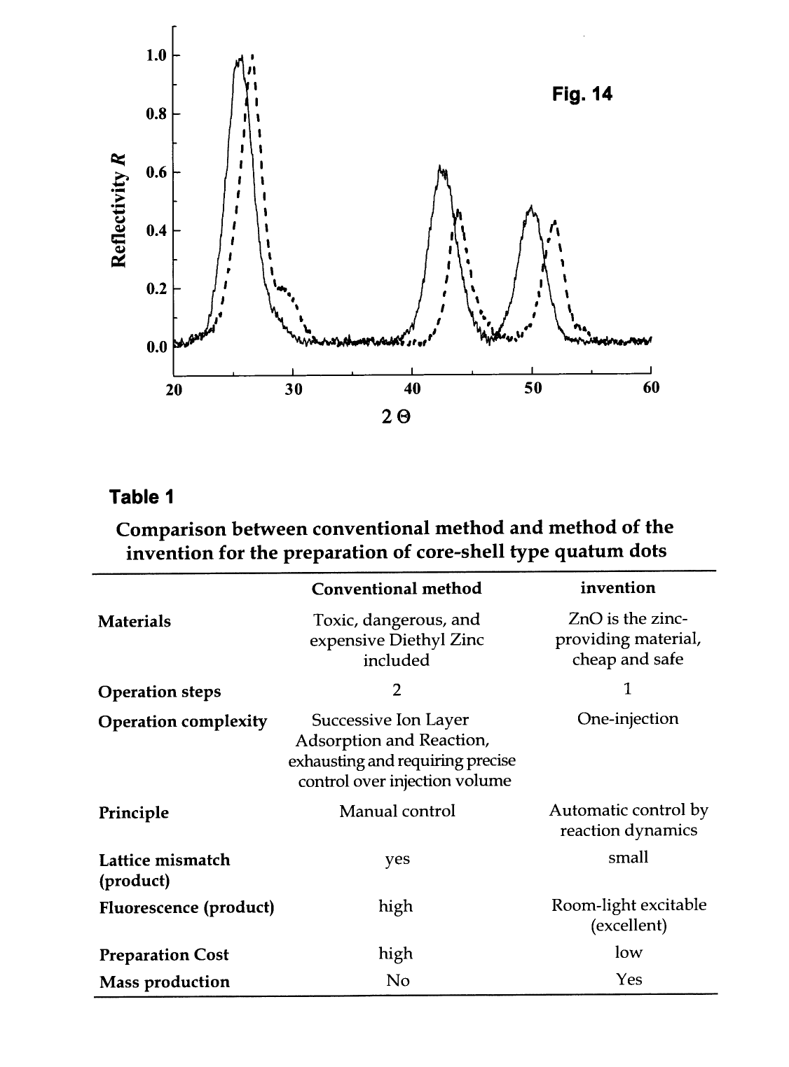

FIG. 14 depicts X-ray diffraction patterns of room-light excitable quantum dots, composed of Cd+Se+S (predicted structure CdSe/CdSeₓS₁₋ₓ/CdS). The dashed curve is measured from the product with a higher S/Se ratio.

As can be taken from these appended figures, nanocrystals can be formed using the process of the present invention. As an example, a nanocrystal obtained by the process of the present invention may be used in an illuminant, an amplifier, in a biological sensor or for computation methods. When used in an illuminant, i.e. a light emitting device such as a lamp, a light emitting diode, a laser diode, a fluorophore (for instance in the detection of tumors), a TV-screen or a computer monitor, the wavelength range, including the peak of light emission, can be adjusted by selecting values for process parameters in the process of the invention. One such embodiment of the invention is a nanocrystal that emits white light. Accordingly, the present invention also relates to the use of a nanocrystal obtainable or obtained by the process of the invention. As can be taken by the illustrative figures, the respective wavelength range, including the emission peak, can be controlled by factors such as the temperature at which the element A is added, the reaction time, the solvent used, the dispersing agent used, and the amount of dispersing agent added.

Any suitable solvent may be used in the process of the present invention. The solvent may be or include a coordinating solvent such as e.g. a thiol, an amine, a phosphine or a phosphine oxide. Where the solvent is a non-coordinating solvent, e.g. octadecene, a surface-binding ligand such as oleic acid may be used. The solvent may in some embodiments include an ether or an amine, such as an alkylamine or a dialkylamine. It may also be or include an ionic liquid such as a phosphonium ionic liquid. In some embodiments the solvent is a weak coordinating solvent. It may also include non-coordinating components such as an alkane or an alkene or strong coordinating components such as tri-n-octylphosphine.

The solvent used in the process of the invention is typically a high-boiling solvent, e.g. with a boiling point above about 120° C., 150° C., 180° C., above about 220° C., above about 250° C., about 280° C., about 300° C. or above about 330° C. In some embodiments a combination of solvent components is selected, which has a boiling point above the highest selected temperature during the process of the invention (e.g. for dissolving cadmium or a cadmium compound). The ether or amine itself may be a high-boiling solvent. Examples of a suitable ether include, but are not limited to, dioctylether (CAS-No. 629-82-3), didecyl ether (CAS-No. 2456-28-2), diundecyl ether (CAS-No. 43146-97-0), didodecyl ether (CAS-No. 4542-57-8), 1-butoxy-dodecane (CAS-No. 7289-38-5), heptyl octyl ether (CAS-No. 32357-84-9), octyl dodecyl ether (CAS-No. 36339-51-2), and 1-propoxy-heptadecane (CAS-No. 281211-90-3). Examples of a suitable amine include, but are not limited to, 1-amino-9-octadecene (oleylamine) (CAS-No. 112-90-3), 1-amino-4-nonadecene (CAS-No. 25728-99-8), 1-amino-7-hexadecene (CAS-No. 225943-46-4), 1-amino-8-heptadecene (CAS-No. 712258-69-0, CAS-No of the pure Z-isomer: 141903-93-7), 1-amino-9-heptadecene (CAS-No. 159278-11-2, CAS-No of the Z-isomer: 906450-90-6), 1-amino-9-hexadecene (CAS-No. 40853-88-1), 1-amino-9-eicosene (CAS-No. 133805-08-0), 1-amino-9,12-octadecadiene (CAS-No. 13330-00-2), 1-amino-8,11-heptadecadiene (CAS-No. 141903-90-4), 1-amino-13-docosene (CAS-No. 26398-95-8), N-9-octadecenyl-propanediamine (CAS-No. 29533-51-5), N-octyl-2,7-octadienyl-amine (CAS-No. 67363-03-5), N-9-octadecen-1-yl-9-octadecen-1-amine (dioleylamine) (CAS-No. 40165-68-2), bis(2,7-octadienyl)amine (CAS-No. 31334-50-6), and N,N-Dibutyl-2,7-octadienylamine (CAS-No. 63407-62-5).

Other compounds that may be included in the solvent include, but are not limited to, an alkyl- or aryl phosphine, a phospine oxide, an alkane, or an alkene. The respective compounds may include long chain alkyl or aryl groups, such as dodecylamine, hexadecylamine, octadecylamine, etc. It is however noted that compounds with such long chain moieties are not required in the process of the present invention. Illustrative examples of an alkene include, but are not limited to, 1-dodecene (CAS-No 112-41-4), 1-tetradecene (CAS-No 1120-36-1), 1-hexadecene (CAS No. 629-73-2), 1-heptadecene (CAS No. 6765-39-5), 1-octadecene (CAS No. 112-88-9), 1-eicosene (CAS No. 3452-07-1), 7-tetradecene (CAS-No 10374-74-0), 9-hexacosene (CAS-No 71502-22-2), 1,13-tetradecadiene (CAS-No 21964-49-8) or 1,17-octadecadiene (CAS-No 13560-93-5). Illustrative examples of an alkane are decane (CAS-No 124-18-5), undecane (CAS-No 1120-21-4), tridecane (CAS-No 629-50-5), hexadecane (CAS-No 544-76-3), octadecane (CAS-No 593-45-3), dodecane (CAS-No 112-40-3) and tetradecane (CAS-No 629-59-4). Illustrative examples of a phosphine are trioctylphosphine, tributylphosphine, tri(dodecyl)phosphine. Illustrative examples of a phosphine oxide are trioctylphosphine oxide, tris(2-ethylhexyl)phosphine oxide, and phenylbis(2,4,6-trimethylbenzoyl)-phosphine oxide.

In some embodiments of the process of the invention the solvent includes both an alkene and an amine. The alkene and the amine may be present in any ratio, such as for instance in the range of about 100:1 (v/v) to about 1:100 (v/v), 10:1 (v/v) to about 1:10 (v/v) or about 5:1 (v/v) to about 1:5 (v/v). In some embodiments the solvent includes both an alkyl phosphine or an aryl phosphine and an amine. The phosphine and the amine may also be present in any ratio, such as for instance in the range of about 100:1 (v/v) to about 1:100 (v/v), about 10:1 (v/v) to about 1:10 (v/v) or about 5:1 (v/v) to about 1:5 (v/v).

It is noted that the process of the present invention can be carried out in the absence of any amine. This is in particular the case for the process in which a nanocrystalline composite being composed of the elements Cd, Se and A is formed. However, it is also within the scope of the present invention that also all other processes described herein are carried out in an essentially amine free solvent. Accordingly, in some embodiments the solvent used is at least substantially void of amines, i.e. amine-free. The term “amine” is used herein it its regular meaning to refer to compounds having at least one primary, secondary or tertiary amine group (compound of the general formula (R₁R₂R₃N with R₁, R₂, and R₃ being hydrogen or an alkyl group, for example) which would be able to react with a metal such a Cd or Zn used in the present invention. This means that it is with the scope of the present invention that the term “amine free” as used refers to any amine compound that is capable of interacting with a metal in the formation of a suitable solution in step (i) of the methods as recited here. Thus, in line with the definition the term “amine free” also includes to include in a reaction mixture used herein an amine that does not have the capability to react with a metal of group 12 of the PSE such as Cd. Illustrative examples of such reactive amines that fall within the definition of the term “amine free” include, but are not limited, to amines with long chain alkyl or aryl groups, such as dodecylamine, hexadecylamine, octadecylamine, dioctylamine, or trioctylamine. In line with the above, the term “at least essentially free of” as used herein for a solvent refers to the use of amounts of a solvent that do not significantly affect the total fluid content. This term thus includes the complete absence and the presence of traces of an amine, for example about 0.01%, about 0.1%, about 0.5%, about 1%, about 2%, about 3%, about 4% or about 5% (in relation to the total volume of the used solvent). Accordingly the main solvent (which can also be a mixture of different solvents other than an amine) in these embodiments of the process of the invention, in which a solution or a reaction mixture as defined herein is prepared, is, or is dominated and governed, by a solvent that differs from an amino compound. As an illustrative example, in such embodiments a non-coordination solvent, e.g. an alkene (an olefin) such as 1-octadecylethylene, 1-octadecenylethylene, 1-eicosene(1-icosene), docosaene, tricosaene, tetracosaene, 7,11-octadecadienylene, 2-methylheptamethylene, 1-butylhexamethylene, 2-methyl-5-ethylheptamethylene, 2,3,6-trimethylheptamethylene, 6-ethyldecamethylene, 7-methyltetradecamethylene, 7-ethylhexadecamethylene, 7,12-dimethyloctadecamethylene, 8,11-dimethyloctadecamethylene, 7,10-dimethyl-7-ethylhexadecamethylene, octadecamethylene or undecamethylene may be used as a solvent, to which a dispersing agent such as a surfactant may be added.

There are two general embodiments of carrying out the process of the invention, albeit combinations and modifications are within the skill of the skilled artisan. In the first embodiment a solution of the metal or metals, or the respective precursor(s), are being formed in a suitable solvent, e.g. a solvent (or mixture of solvents) as listed above. To the solution thereby formed one or two chalcogens are added. In the second embodiment the metal or metals, or the respective precursor(s), and one or two chalcogens are added to the respective solvent without previously forming a metal solution. This second embodiment can thus also be described as a “one pot reaction”. In this second embodiment it may be desired to remove water from the system while the reaction of forming a nanocrystalline composite in the process of the invention is carried out. Removing water will avoid or prevent the risk of ignitions and/or explosions due to side reactions of water generated. Removal of water can be carried out using any known respective (standard) methods used in organic chemistry. For example, the water can be removed by using a condenser together with a water-splitter. Alternatively or in addition, instead of using (only) physical methods such as condensation and subsequent separation of the water that is formed in the course of the reaction, it is possible to remove the water by chemical reaction such as reaction with a dessicant such as calcium oxide. Provided the dessicant does not interfere with the reaction, it can be included into the reaction mixture. Otherwise, the dessicant can be placed outside the reaction mixture and react with the evaporating water.

One metal used in the process is cadmium. Cadmium may be used, for example, in the form of elemental cadmium or in form of a cadmium precursor. A cadmium precursor is generally formed from a cadmium compound or from elemental cadmium that is provided and added to the solvent. Any cadmium compound may be used that can be dissolved in the selected solvent and that is of sufficient reactivity for the formation of a nanocrystal. It may in some embodiments be desired to select a cadmium compound that is of a certain reactivity, e.g. moderate reactivity, that allows convenient control on the progress of the reaction process. Such selection may for example be desired if the process is carried out at a scale that exceeds the typical laboratory scale, for instance at the scale of about a litre or about tens or hundreds of litres. The cadmium compound may for example be an inorganic cadmium salt such as cadmium carbonate and cadmium chloride. The cadmium compound may also be an organic cadmium compound (e.g. salt) such as cadmium acetate or cadmium acetylacetonate. In some embodiments a cadmium compound is used that differs from an organic compound, i.e. which is not an organic compound. Such a compound may also be a cadmium oxide or a cadmium hydroxide. Nevertheless the respective cadmium compound may be dissolved and be converted into a cadmium salt such as an inorganic or organic salt (see below). Forming a solution of the cadmium compound, respectively, may in some embodiments include bringing the solvent to an elevated temperature. After dissolving cadmium or the cadmium compound, the temperature of the solution may be changed, such as reduced to a selected temperature.

The cadmium precursor is also a cadmium compound, which may in some embodiments however differ from the cadmium or cadmium compound provided for carrying out the process according to the invention. As an illustrative example, in some embodiments the cadmium precursor is an organic cadmium compound. A solution of such a cadmium organic compound may be formed in the solvent used. The cadmium organic compound may be obtained by or having its inorganic counterparts reacting with a long chain organic acid, possibly, in the presence of the solvent. Most of inorganic and organic cadmium compounds may be used to form soluble organic salts in the selected solvent. Four illustrative examples of a suitable starting cadmium compound are cadmium oxide, cadmium hydroxide, cadmium carbonate (CdCO₃), and cadmium chloride (CdCl₂). Illustrative examples of organic compounds that may be formed during the reaction are organic salts such as cadmium oleate and cadmium stearate. In some embodiments the cadmium precursor is an inorganic cadmium salt. Upon adding an organic acid such as an organic carboxylic acid, which is typically a long chain organic carboxylic acid, to the solution of the inorganic cadmium salt (which can also be obtained by dissolving cadmium oxide) an organic cadmium salt such as cadmium salt of an organic carboxylic acid, may be formed.

In this regard the process of the invention may also include adding a dispersing agent, e.g. a surfactant (see also above). The dispersing agent may serve as a coordination ligand for a metal or the metals used in the process of the invention. The dispersing agent may also assist in coordinating the respective metal or metals. The dispersing agent may be added to the solvent before a solution of cadmium, or a cadmium compound, is formed, at the same time or thereafter. The dispersing agent may also be added to the solution of cadmium, or the cadmium compound, which has been formed in the respective solvent. Typically the dispersing agent is added before sulphur or selenium (see also below), or a compound thereof, are added. The dispersing agent generally includes polar head groups, which may be hydrogen containing groups. Any surfactant may for instance be used as the dispersing agent. The surfactant may for instance be an organic carboxylic acid, an organic phosphate, an organic phosphonic acid, an organic sulfonic acid or a mixture thereof. Illustrative examples of suitable organic carboxylic acid include, but are not limited to, stearic acid (octadecanoic acid), lauric, acid, oleic acid ([Z]-octadec-9-enoic acid), n-undecanoic acid, linoleic acid, ((Z,Z)-9,12-octadecadienoic acid), arachidonic acid ((all-Z)-5,8,11,14-eicosatetraenoic acid), linelaidic acid ((E,E)-9,12-octadecadienoic acid), myristoleic acid (9-tetradecenoic acid), palmitoleic acid (cis-9-hexadecenoic acid), myristic acid (tetradecanoic acid), palmitic acid (hexadecanoic acid) and γ-homolinolenic acid ((Z,Z,Z)-8,11,14-eicosatrienoic acid). Examples of other surfactants (an organic phosphonic acid, for example) include hexylphosphonic acid and tetradecylphosphonic acid. It has previously been observed that oleic acid is capable of stabilising nanocrystals and allows the usage of octadecene as a solvent (Yu, W. W., & Peng, X., Angew. Chem. Int. Ed. (2002) 41, 13, 2368-2371). In the synthesis of other nanocrystals surfactants have been shown to affect the crystal morphology of the nanocrystals formed (Zhou, G., et al., Materials Lett. (2005) 59, 2706-2709). In embodiments where a solution of the metal or metals, or the respective precursor(s), are being formed in a suitable solvent the surfactant may in some embodiments be added together with one or more of the metal or metals, or the respective precursor(s). In embodiments where the metal or metals, or the respective precursor(s), and one or two chalcogens are brought in contact without previously forming a metal solution, the surfactant may for example be added together with the metal or metals and/or together with the one or two chalcogens.

In some embodiments a further metal M or a precursor thereof is used. The precursor of the further metal M is generally formed from a compound of the metal M or from elemental metal M. The respective compound or elemental metal is provided for carrying out the process of the invention and added to the solvent. Any metal compound may be used that can be dissolved in the selected solvent. The metal compound may for example be an inorganic metal salt such as a carbonate or a chloride or an organic compound (e.g. salt) such as an acetate or an acetylacetonate. In such embodiments where both a metal M and Cd or respective precursors are used a solution of both cadmium or a cadmium precursor and of the metal M or a precursor of M is formed. The metal M is an element of group 12 of the periodic table of the chemical elements (according to the new IUPAC system, group IIB according to the CAS system and the old IUPAC system) other than Cd. The metal M may for instance be Zn or a precursor thereof. The above said regarding the precursor of Cd applies mutatis mutandis to the metal M. For example, a Zn compound such as an inorganic zinc salt, e.g. zinc carbonate or zinc chloride, or an organic zinc salt such as zinc acetate or zinc acetylacetonate may be used. The compound may also be a zinc oxide or zinc hydroxide.

Where two metals or metal precursors are used, e.g. cadmium and zinc or oxides thereof, the two metals/precursors may be used in any desired ratio. Cadmium or the cadmium precursor and the metal M or the precursor of M may for instance be used in a molar ratio in the range from about 500:1 to about 1:500, about 100:1 to about 1:100, about 50:1 to about 1:50, about 20:1 to about 1:20, about 15:1 to about 1:15, about 10:1 to about 1:10, about 5:1 to about 1:5 or about 2:1 to about 1:2. In some embodiments the ratio of cadmium or cadmium precursor and the metal M or the precursor of M is about 1:1. In some embodiment, a slight molar excess of cadmium (or its precursor) to the metal M (or its precursor) or vice versa may be used. Such a slight excess may for instance be employed where it is desired to ensure a certain minimum width (e.g. thickness) of the core or the shell, or where it is desired to react the respective metal as far as possible, e.g. in order to at least substantially convert the respective metal into a component of a nanocrystal formed.

Forming a solution of Cd or a Cd precursor, and, where applicable of the metal M or a precursor of the metal M includes adding the respective metal components (Cd or Cd precursor, M or M precursor) to a suitable solvent. In some embodiments forming a solution of Cd or a Cd precursor, and, where applicable of the metal M or a precursor of metal M further includes increasing the temperature of the solvent. The solvent may for example be brought to a temperature from about 50° C. to about 450° C., such as about 50° C. to about 400° C., about 100° C. to about 400° C., about 100° C. to about 350° C., about 100° C. to about 300° C., about 150° C. to about 300° C., about 200° C. to about 300° C. or about 250° C. to about 300° C.

As noted above, in some embodiments of the process of the invention a solution of the metal or metals, or the respective precursor(s), is formed in a suitable solvent, and one or two chalcogens are added to the corresponding solution. The chalcogen(s) are typically added in a solvent, which may be any solvent. In some embodiments a coordinating solvent such as e.g. a thiol, an amine, a phosphine (e.g. triheptylphosphine, trioctylphosphine, trinonylphosphine, triphenylphosphine) or a phosphine oxide (e.g. trioctylphosphine oxide, triphenylphosphine oxide, tris(2-ethylhexyl)phosphine oxide). In some embodiments the chalcogen(s) is/are dissolved in the respective solvent(s). In some embodiments where two chalcogens are added both chalcogens may be added, including dissolved, in the same solvent. In some embodiments where two chalcogens are added both chalcogens may be provided together in a common solvent. In some embodiments where two chalcogens are added the two chalcogens are added separately in different, suspensions, dispersions, solutions etc. formed using the same solvent.

The chalcogen(s) is/are added in a form suitable for the generation of a nanocrystal. Typically the chalcogen(s) is/are added in the form of the elemental chalcogen. One chalcogen that is used in all embodiments of the process of the invention is selenium. In some embodiments an additional chalcogen besides selenium is used. This chalcogen may be any element of group 16 of the periodic table of the chemical elements (according to the new IUPAC system, group VIA according to the CAS system and group VIB according to the old IUPAC system) other than oxygen and selenium. Examples of suitable chalcogens are sulphur, and tellurium. The chalcogen(s) may be added in any suitable solvent such as for instance a phosphine, e.g. tri-n-octylphosphine (TOP, CAS No. 4731-53-7), tri-n-nonyl-phosphine (CAS No. 17621-06-6), tri-n-heptylphosphine (CAS No 17621-04-4), tri-n-hexylphosphine (CAS No. 4168-73-4), tri-n-butylphosphine (CAS No 998-40-3), tri-p-tolyl-phosphine (CAS No 1038-95-5), tri-1-naphthyl-phosphine (CAS No 3411-48-1) or triphenylphosphine (CAS No 603-35-0). In embodiments where the metal or metals, or the respective precursor(s), and one or two chalcogens are brought in contact without previously forming a metal solution, the same chalcogen(s) may be used.

Where two chalcogens are used, e.g. selenium and sulfur, the two chalcogens may be used in any desired ratio. Selenium and the chalcogen A may for instance be used in a molar ratio in the range from about 500:1 to about 1:500, about 100:1 to about 1:100, about 50:1 to about 1:50, about 20:1 to about 1:20, about 15:1 to about 1:15, about 10:1 to about 1:10, about 5:1 to about 1:5 or about 2:1 to about 1:2. In some embodiments the ratio of Se and A is about 1:1. In this regard the molar ratios between cadmium or the cadmium precursor and selenium used may likewise be selected as desired. Thus, the molar ratio of Cd or Cd precursor and selenium may for instance be selected in a in the range from about 500:1 to about 1:500, about 100:1 to about 1:100, about 50:1 to about 1:50, about 20:1 to about 1:20, about 15:1 to about 1:15, about 10:1 to about 1:10, about 5:1 to about 1:5 or about 2:1 to about 1:2. In some embodiments the ratio of Cd or Cd precursor and Se is about 1:1. In one embodiment the combination of cadmium and the other metal M is used is equimolar amounts relative to selenium, or relative to selenium together with the other element of the group 12 of the PSE.

In a further embodiment, a slight molar excess of the chalcogen to cadmium, or to the combined amount of cadmium and the other group 12 PSE element may be used, for example to ensure that the respective metal is completely reacted in the process of the invention. For illustrative purposes it is mentioned here that the molar ratio between the two chalcogens can be used in order to influence the structure of the nanocrystallite formed. Using, for purpose of illustration, a composite of the formula CdSe/ZnₓCd₁₋ₓSe/ZnSe, if Cd and Zn are used in an equimolar ratio (1:1) then a rather thick mantle structure (this mantle may have some homogenous alloy type structure ZnₓCd₁₋ₓSe) and a rather thin shell ZnSe as illustrated in FIG. 2 may be formed. Alternatively, if Cd and Zn are used in a molar ratio of 1:9 (at the molar ratio of the chalcogens to Se being kept constant) then a rather thin mantle structure of ZnₓCd₁₋ₓSe and a rather thick ZnSe shell as illustrated in FIG. 2 are formed. Without wishing to be bound by theory, it is believed that this shell can be thicker than in regular core-shell CdSe/ZnSe nanocrystals. The reason for this increased thickness is that due to 9 molar excess of Zn compared to Cd, there is more Zn left after formation of the CdSe core (for which most of the Cd is reacted) and the formation of the very thin mantle, which may even not be detectable by analytical method.

In some embodiments where a solution of the metal or metals, or the respective precursor(s), is formed, the solution may further be heated before adding the chalcogen(s). It may for example be brought to a temperature selected in the range from about 100° C. to about 400° C., from about 150° C. to about 500° C., from about 150° C. to about 300° C., from about 200° C. to about 400° C., from about 250° C. to about 350° C. or from about 300° C. to about 350° C. At the respective temperature the element A, i.e. selenium alone or used together with sulphur or tellurium, is added in a form suitable for the generation of a nanocrystal. As mentioned above, for this purpose, the chalcogen can be dissolved in a solvent such as TOP.

Where the chalcogen(s) is/are added to a solution of one or two metals, this addition may be carried out by injecting the chalcogen(s). On a laboratory scale, for example on the scale of about 500 ml or below, a syringe may for instance be used for this purpose. In some embodiments a pump may be used to inject the chalcogen(s). In some embodiments the chalcogen(s) is/are added rapidly. In some embodiments the chalcogen(s) are added separately. In some embodiments the chalcogen(s) are added together. By adding the chalcogen(s) to the solution of cadmium or the cadmium precursor a reaction mixture is formed. As noted above, in some embodiments both the metal or metals, or the respective precursor(s), and the chalcogen(s) are added to a solvent without forming a solution of the metal(s). Thereby the reaction mixture is formed in these embodiments.

In the process of the invention the reaction mixture is further heated. It may for example be brought to a temperature selected in the range from about 100° C. to about 400° C., from about 150° C. to about 500° C., from about 150° C. to about 300° C., from about 150° C. to about 400° C., from about 200° C. to about 400° C., from about 250° C. to about 350° C. or from about 300° C. to about 350° C. At the respective temperature the element A, i.e. sulphur or selenium, is added in a form suitable for the generation of a nanocrystal. The respective element may be added in any suitable solvent such as for instance a phosphine, e.g. tri-n-octyl-phosphine (CAS No. 4731-53-7), tri-n-nonyl-phosphine (CAS No. 17621-06-6), tri-n-heptylphosphine (CAS No 17621-04-4), tri-n-hexylphosphine (CAS No. 4168-73-4), tri-n-butylphosphine (CAS No 998-40-3), tri-p-tolyl-phosphine (CAS No 1038-95-5), tri-1-naphthylphosphine (CAS No 3411-48-1) or triphenylphosphine (CAS No 603-35-0).

The reaction mixture is heated for a time period that is sufficient to allow the formation of the Cd and Se containing nanocrystalline composite. The desired period of time may be determined using standard techniques available in the art. The progress of the reaction may for example be monitored by detecting the photoluminescence as illustrated in FIG. 5. The reaction may be carried out for any desired period of time, ranging from milliseconds to a plurality of hours, including a few minutes, e.g. 2 or 5 minutes, about 10 to about 15 minutes, to about 30 minutes or to about 45 minutes. Where desired, the reaction is carried out in an inert atmosphere, i.e. in the presence of gases that are not reactive, or at least not reactive to a detectable extent, with regard to the reagents and solvents used. Examples of a reactive inert atmosphere are nitrogen or a noble gas such as argon or helium.

Typically the reaction mixture is allowed to cool once the selected time period of heating the reaction mixture is passed. The formed Cd and Se containing nanocrystalline composite may then be isolated.

The process of the invention can conveniently be used to prepare nanocrystals, including light emitting quantum dots. In this regard it is noted that in contrast to other methods known in the art, such as e.g. described in WO 2004/054923, the inventors surprisingly found that using the process of the invention a composite nanocrystal rather than a homogenous alloy is formed. Typically a formed nanocrystal is core-shelled. It is assumed that the difference in the dynamic reaction rate for the core- and the shell-materials causes the formation of this composite structure. Without the intend of being bound by theory indications suggest that depending on the starting materials used the nanocrystalline composite obtained by a method according to the invention may have one of the following structures, which are schematically presented in the form core/mantle/shell: (1) CdSe/Cd₁₋ₓMₓSe/MSe, (2) CdSe/Cd₁₋ₓSeAₓ/CdA, and (3) Cdₓ/Se_{y}/M₁₋ₓ/A_{1-y}. In these formulas x is any value from 0 to 1, such as from about 0.001 to about 0.999, from about 0.01 to about 0.99 or from about 0.5 to about 0.95. In some embodiments x may be around 0.5. In the third schematically presented structure y is any value from 0 to 1, such as from about 0.001 to about 0.999, from about 0.01 to about 0.99 or from about 0.5 to about 0.95. In some embodiments y may be around 0.5. In this structure the ratio of x:y may be any desired value. It may for example be selected in the range from about 100:1 to about 1:100, from about 10:1 to about 1:10 or from about 5:1 to about 1:5. In some embodiments the ratio of x:y may be around 1:1.

The intact passivation on the emission center, the core, renders water-soluble conversion of the quantum dots extremely easy with reasonable fluorescence intensity being retained. The inventors further found indications that using the process of the invention nanocrystals with a particularly small core, relative to the shell, can be formed. Without wishing to be bound by theory there are indications that a mantle is formed between the core and the shell (FIG. 2). This mantle layer can serve as a lattice parameter transition “glue” layer, and reduce the lattice mismatch problem which is common for conventional core-shell quantum dots. It is assumed that a core-shell structure is initially formed and that the formation of the thin mantle layer occurs during annealing of the nanocrystals. Presumably a thin alloy layer is formed, which matches both the core and the shell materials in lattice parameters.

Nanocrystals can be formed using the process of the invention in which the shell is of larger thickness than the mantle. As an illustrative example, the core of a nanocrystal formed by the process of the invention may be of a width (e.g. diameter) below 10 nm, including below 5 nm or below 3 nm, while the entire nanocrystal may be of a width (e.g. diameter) in the range from about 2 to about 50 nm, such as from about 5 to about 20 nm, about 6 to about 15 nm, e.g. about 7 nm, about 8 nm, about 9 nm, about 10 nm, about 11 nm or about 12 nm. Different sizes of cores and shells can further be formed by varying the ratio of the metals used, e.g. the ratio of cadmium and the metal M such as zinc, and/or by varying the ratio of selenium and the second chalcogen used, such as tellurium or sulphur.

It is noted in this regard that the composite nanocrystal is formed without the requirement of separately forming first a core and subsequently forming a shell. Rather, the composite nanocrystal is formed in situ when using the process according to the invention. Accordingly, quantum dots with a core-shell structure can be formed via a “one-injection” approach that offers the opportunity for (easy and inexpensive) mass production of such quantum dots and their derivatized products (cf., Examples 11 to 13). Further, this composite, e.g. core-shelled, structure remains intact upon heating, such that no homogenous alloy is formed upon reheating nanocrystals formed according to the process of the invention. As noted above, these nanocrystals formed according to the process of the invention are in typical embodiments fluorescent and capable of emitting light and can thus be addressed as quantum dots. Typically these quantum dots fluoresce even in weak room light without any additional excitation source. A desired fluorescence emission wavelength of these quantum dots can be selected by selecting a corresponding ratio of the metals used, e.g. the ratio of cadmium and the metal M such as zinc (see e.g. FIG. 8), and/or by varying the ratio of selenium and the second chalcogen used, such as tellurium or sulphur.

A nanocrystalline composite formed by a process according to the invention, including a plurality thereof, e.g. in the form of an arrays of densely packed dots, may be used for forming a light emitting arrangement of nanocrystals such as a light emission layer and/or for forming a light emitting device.

The process of the invention may further include nanocrystal post-processing. Although the nanocrystals obtained by the process of the invention are generally at least essentially or at least almost monodisperse, if desired a step may be performed to narrow the size-distribution (for example as a precaution or a safety-measure). Such techniques, e.g. size-selective precipitation, are well known to those skilled in the art. The surface of the nanocrystal may also be altered, for instance coated.

In some embodiments the nanocrystal (or the plurality thereof) formed by the process of the invention is coupled to a molecule with binding affinity for a selected target molecule, such as a microorganism, a virus particle, a peptide, a peptoid, a protein, a nucleic acid, a peptide, an oligosaccharide, a polysaccharide, an inorganic molecule, a synthetic polymer, a small organic molecule or a drug.

The term “nucleic acid molecule” as used herein refers to any nucleic acid in any possible configuration, such as single stranded, double stranded or a combination thereof. Nucleic acids include for instance DNA molecules (e.g., cDNA or genomic DNA), RNA molecules (e.g., mRNA), analogues of the DNA or RNA generated using nucleotide analogues or using nucleic acid chemistry, locked nucleic acid molecules (LNA), and protein nucleic acids molecules (PNA). DNA or RNA may be of genomic or synthetic origin and may be single or double stranded. In the present method of the invention typically, but not necessarily, an RNA or a DNA molecule will be used. Such nucleic acid can be e.g. mRNA, cRNA, synthetic RNA, genomic DNA, cDNA synthetic DNA, a copolymer of DNA and RNA, oligonucleotides, etc. A respective nucleic acid may furthermore contain non-natural nucleotide analogues and/or be linked to an affinity tag or a label. In some embodiments the nucleic acid molecule may be isolated, enriched, or purified. The nucleic acid molecule may for instance be isolated from a natural source by cDNA cloning or by subtractive hybridization. The natural source may be mammalian, such as human, blood, semen, or tissue. The nucleic acid may also be synthesized, e.g. by the triester method or by using an automated DNA synthesizer.

Many nucleotide analogues are known and can be used in nucleic acids and oligonucleotides used for coupling to a nanocrystalline composite of the invention. A nucleotide analogue is a nucleotide containing a modification at for instance the base, sugar, or phosphate moieties. Modifications at the base moiety include natural and synthetic modifications of A, C, G, and T/U, different purine or pyrimidine bases, such as uracil-5-yl, hypoxanthin-9-yl, and 2-aminoadenin-9-yl, as well as non-purine or non-pyrimidine nucleotide bases. Other nucleotide analogues serve as universal bases. Universal bases include 3-nitropyrrole and 5-nitroindole. Universal bases are able to form a base pair with any other base. Base modifications often can be combined with for example a sugar modification, such as for instance 2′-O-methoxyethyl, e.g. to achieve unique properties such as increased duplex stability.

A peptide may be of synthetic origin or isolated from a natural source by methods well-known in the art. The natural source may be mammalian, such as human, blood, semen, or tissue. A peptide, including a polypeptide may for instance be synthesized using an automated polypeptide synthesizer. Illustrative examples of polypeptides are an antibody, a fragment thereof and a proteinaceous binding molecule with antibody-like functions. Examples of (recombinant) antibody fragments are Fab fragments, Fv fragments, single-chain Fv fragments (scFv), diabodies, triabodies (Iliades, P., et al., FEBS Lett (1997) 409, 437-441), decabodies (Stone, E., et al., Journal of Immunological Methods (2007) 318, 88-94) and other domain antibodies (Holt, L. J., et al., Trends Biotechnol. (2003), 21, 11, 484-490). An example of a proteinaceous binding molecule with antibody-like functions is a mutein based on a polypeptide of the lipocalin family (WO 03/029462, Beste et al., Proc. Natl. Acad. Sci. U.S.A. (1999) 96, 1898-1903). Lipocalins, such as the bilin binding protein, the human neutrophil gelatinase-associated lipocalin, human Apolipoprotein D or glycodelin, posses natural ligand-binding sites that can be modified so that they bind to selected small protein regions known as haptens. Examples of other proteinaceous binding molecules are the so-called glubodies (see e.g. internation patent application WO 96/23879), proteins based on the ankyrin scaffold (Mosavi, L. K., et al., Protein Science (2004) 13, 6, 1435-1448) or crystalline scaffold (e.g. internation patent application WO 01/04144) the proteins described in Skerra, J. Mol. Recognit. (2000) 13, 167-187, AdNectins, tetranectins and avimers. Avimers contain so called A-domains that occur as strings of multiple domains in several cell surface receptors (Silverman, J., et al., Nature Biotechnology (2005) 23, 1556-1561). Adnectins, derived from a domain of human fibronectin, contain three loops that can be engineered for immunoglobulin-like binding to targets (Gill, D. S. & Damle, N. K., Current Opinion in Biotechnology (2006) 17, 653-658). Tetranectins, derived from the respective human homotrimeric protein, likewise contain loop regions in a C-type lectin domain that can be engineered for desired binding (ibid.). Peptoids, which can act as protein ligands, are oligo(N-alkyl)glycines that differ from peptides in that the side chain is connected to the amide nitrogen rather than the α carbon atom. Peptoids are typically resistant to proteases and other modifying enzymes and can have a much higher cell permeability than peptides (see e.g. Kwon, Y.-U., and Kodadek, T., J. Am. Chem. Soc. (2007) 129, 1508-1509).

As a further illustrative example, a linking moiety such as an affinity tag may be used to immobilise the respective molecule. Such a linking moiety may be a molecule, e.g. a hydrocarbon-based (including polymeric) molecule that includes nitrogen-, phosphorus-, sulphur-, carben-, halogen- or pseudohalogen groups, or a portion thereof. As an illustrative example, the selected surface may include, for instance be coated with, a brush-like polymer, for example with short side chains. The immobilisation surface may also include a polymer that includes a brush-like structure, for example by way of grafting. It may for example include functional groups that allow for the covalent attachment of a biomolecule, for example a molecule such as a protein, a nucleic acid molecule, a polysaccharide or any combination thereof. Examples of a respective functional group include, but are not limited to, an amino group, an aldehyde group, a thiol group, a carboxyl group, an ester, an anhydride, a sulphonate, a sulphonate ester, an imido ester, a silyl halide, an epoxide, an aziridine, a phosphoramidite and a diazoalkane.

Examples of an affinity tag include, but are not limited to biotin, dinitrophenol or digoxigenin, oligohistidine, polyhistidine, an immunoglobulin domain, maltose-binding protein, glutathione-S-transferase (GST), calmodulin binding peptide (CBP), FLAG′-peptide, the T7 epitope (Ala-Ser-Met-Thr-Gly-Gly-Gln-Gln-Met-Gly), maltose binding protein (MBP), the HSV epitope of the sequence Gln-Pro-Glu-Leu-Ala-Pro-Glu-Asp-Pro-Glu-Asp of herpes simplex virus glycoprotein D, the hemagglutinin (HA) epitope of the sequence Tyr-Pro-Tyr-Asp-Val-Pro-Asp-Tyr-Ala, the “myc” epitope of the transcription factor c-myc of the sequence Glu-Gln-Lys-Leu-Ile-Ser-Glu-Glu-Asp-Leu, or an oligonucleotide tag. Such an oligonucleotide tag may for instance be used to hybridise to an immobilised oligonucleotide with a complementary sequence. A further example of a linking moiety is an antibody, a fragment thereof or a proteinaceous binding molecule with antibody-like functions (see also above).

A further example of linking moiety is a cucurbituril or a moiety capable of forming a complex with a cucurbituril. A cucurbituril is a macrocyclic compound that includes glycoluril units, typically self-assembled from an acid catalyzed condensation reaction of glycoluril and formaldehyde. A cucurbit[n]uril, (CB[n]), that includes n glycoluril units, typically has two portals with polar ureido carbonyl groups. Via these ureido carbonyl groups cucurbiturils can bind ions and molecules of interest. As an illustrative example cucurbit[7]uril (CB[7]) can form a strong complex with ferrocenemethylammonium or adamantylammonium ions. Either the cucurbit[7]uril or e.g. ferrocenemethylammonium may be attached to a biomolecule, while the remaining binding partner (e.g. ferrocenemethylammonium or cucurbit[7]uril respectively) can be bound to a selected surface. Contacting the biomolecule with the surface will then lead to an immobilisation of the biomolecule. Functionalised CB[7] units bound to a gold surface via alkanethiolates have for instance been shown to cause an immobilisation of a protein carrying a ferrocenemethylammonium unit (Hwang, I., et al., J. Am. Chem. Soc. (2007) 129, 4170-4171).

Further examples of a linking moiety include, but are not limited to an oligosaccharide, an oligopeptide, biotin, dinitrophenol, digoxigenin and a metal chelator (cf. also below). As an illustrative example, a respective metal chelator, such as ethylenediamine, ethylenediaminetetraacetic acid (EDTA), ethylene glycol tetraacetic acid (EGTA), diethylenetriaminepentaacetic acid (DTPA), N,N-bis(carboxymethyl)glycine (also called nitrilotriacetic acid, NTA), 1,2-bis(o-aminophenoxy)ethane-N,N,N′,N′-tetraacetic acid (BAPTA), 2,3-dimercapto-1-propanol (dimercaprol), porphine or heme may be used in cases where the target molecule is a metal ion. As an example, EDTA forms a complex with most monovalent, divalent, trivalent and tetravalent metal ions, such as e.g. silver (Ag⁺), calcium (Ca²⁺), manganese (Mn²⁺), copper (Cu²⁺), iron (Fe²⁺), cobalt (Co³⁺) and zirconium (Zr⁴⁺), while BAPTA is specific for Ca²⁺. In some embodiments a respective metal chelator in a complex with a respective metal ion or metal ions defines the linking moiety. Such a complex is for example a receptor molecule for a peptide of a defined sequence, which may also be included in a protein. As an illustrative example, a standard method used in the art is the formation of a complex between an oligohistidine tag and copper (Cu²⁺), nickel (Ni²⁺), cobalt (Co²⁺), or zinc (Zn²⁺) ions, which are presented by means of the chelator nitrilotriacetic acid (NTA).

Avidin or streptavidin may for instance be employed to immobilise a biotinylated nucleic acid, or a biotin containing monolayer of gold may be employed (Shumaker-Parry, J. S., et al., Anal. Chem. (2004) 76, 918). As yet another illustrative example, the biomolecule may be locally deposited, e.g. by scanning electrochemical microscopy, for instance via pyrrole-oligonucleotide patterns (e.g. Fortin, E., et al., Electroanalysis (2005) 17, 495). In other embodiments, in particular where the biomolecule is a nucleic acid, the biomolecule may be directly synthesised on the surface of the immobilisation unit, for example using photoactivation and deactivation. As an illustrative example, the synthesis of nucleic acids or oligonucleotides on selected surface areas (so called “solid phase” synthesis) may be carried out using electrochemical reactions using electrodes. An electrochemical deblocking step as described by Egeland & Southern (Nucleic Acids Research (2005) 33, 14, e125) may for instance be employed for this purpose. A suitable electrochemical synthesis has also been disclosed in US patent application US 2006/0275927. In some embodiments light-directed synthesis of a biomolecule, in particular of a nucleic acid molecule, including UV-linking or light dependent 5′-deprotection, may be carried out.

The molecule that has a binding affinity for a selected target molecule may be immobilised on the nanocrystals by any means. As an illustrative example, an oligo- or polypeptide, including a respective moiety, may be covalently linked to the surface of nanocrystals via a thio-ether-bond, for example by using w functionalized thiols. Any suitable molecule that is capable of linking a nanocrystal of the invention to a molecule having a selected binding affinity may be used to immobilise the same on a nanocrystal. For instance a (bifunctional) linking agent such as ethyl-3-dimethylaminocarbodiimide, N-(3-aminopropyl)3-mercapto-benzamide, 3-aminopropyl-trimethoxysilane, 3-mercaptopropyl-trimethoxysilane, 3-(trimethoxysilyl)propyl-maleimide, or 3-(trimethoxysilyl)propyl-hydrazide may be used. Prior to reaction with the linking agent, the surface of the nanocrystals can be modified, for example by treatment with glacial mercaptoacetic acid, in order to generate free mercaptoacetic groups which can then employed for covalently coupling with an analyte binding partner via linking agents.

In order that the invention may be readily understood and put into practical effect, particular embodiments will now be described by way of the following non-limiting examples.

### Exemplary Embodiments of the Invention

### General

A colloidal wet chemistry approach was universally taken in the following examples. Tri-n-octyl phosphine (TOP, 90%), tri-n-octyl phosphine oxide (TOPO, 99%), n-hexadecylamine (99%), 1-octadecene (ODE, 90%), 1-Eicosene (90%), oleic acid (90%), cadmium carbonate (99.999%), cadmium acetate hydrate (99.99+%), zinc oxide (99.999%), zinc acetate (99.99%), sulfur powder (99.98%) and selenium (100 mesh, 99.999%) were all products of Aldrich; Cadmium oxide (99.999%) was a product of Strem Chemicals, USA, and the basic zinc carbonate monohydrate (ZnCO₃.2Zn(OH)₂.H₂O, 97%) was from Lancaster Chemicals. All solvents used are from Aldrich with AR-grade of purity.

The quantum dots are prepared in a non-water solvent with high boiling point, e.g. 1-octadecene. In general, they possess a structure of CdSe/CdMSe/MSe (cf. FIG. 2; M is a IIB metal element, and CdMSe denotes an alloy, e.g., ZnₓCd₁₋ₓSe) or CdSe/CdSeA/CdA (cf. FIG. 2, A is a VIA non-metal element, and CdSeA denotes an alloy, e.g., CdSₓSe₁₋ₓ) in case of three-component quantum dots, or more complicated ones if 4-componenet quantum dots are prepared following a similar approach. The capping agents used to passivate the highly energetic surface of the quantum dots is oleic acid or stearic acid. The as-prepared quantum dots are readily dispersed in non-water solvents, such as hexane, chloroform, and toluene. Their water-soluble counterparts are available if a surface ligand exchange process is conducted by simply mixing the non-water quantum dots solution (preferred chloroform or toluene, in which most thiols are soluble) with thiol or their solution, shaking, centrifugation, washing with chloroform, and re-dispersing in water or phosphate buffered saline.

### Preparation of 3-Component CdSe/CdMSe/MSe (cf. FIG. 2)

In this approach two cation-providing materials (e.g., CdO and ZnO, CdAc₂ and ZnAc₂, CdCO₃ and ZnCO₃.2Zn(OH)₂.H₂O. All these couples have been successfully tested) in different ratios (depending on the desired emission wavelength, e.g., more Zn leads to shorter wavelength emission) are firstly reacted with oleic acid in ODE to form a uniform solution of an oleate salt mixture. At elevated temperature (300° C. in most cases), a trioctylphosphine (TOP) solution of a VIA non-metal element (e.g., TOP/Se) was injected. Temperature was maintained for 30 minutes, before the heater was removed and the solution was allowed to cool down to room temperature whilst vigorous stirring. Many tests suggest that the fluorescence emission can be finely tuned by simply changing the ratio of the starting cation-providing materials. Two examples are given below:

### EXAMPLE 1

### Preparation of CdSe/ZnₓCd₁₋ₓSe/ZnSe (Zn:Cd:Se=1:1:2)

Materials:
1. 0.064 g Cadmium Oxide (CdO, 0.5 mmol)
2. 0.041 g Zinc Oxide (ZnO, 0.5 mmol)
3. 1.28 mL Oleic Acid (OA, 4.0 mmol)
4. 12 mL 1-Octadecylethylene (ODE)
5. 1.2 mL 1M Selenium in TOP (TOP/Se, 1.2 mmol)

Materials 1-4 were placed in a 50 mL three-neck flask equipped with thermometer sensor. After degassing/purging with nitrogen gas for 3 times, the mixture was heated to 300° C. with stirring, until a clear and colorless solution formed. 5 was then swiftly injected into the hot reaction mixture, and the reaction was left running for 30 minutes (from the start of the injection), before the heater was removed. The reaction mixture was further stirred until it reaches room temperature. Shining bright-red quantum dots (with no UV lamp) were obtained.

### EXAMPLE 2

### Preparation of CdSe/ZnₓCd₁₋ₓSe/ZnSe (Zn:Cd:Se=9:1:10)

Materials:
1. 0.013 g Cadmium Oxide (CdO, 0.1 mmol)
2. 0.073 g Zinc Oxide (ZnO, 0.9 mmol)
3. 1.28 mL Oleic Acid (OA, 4.0 mmol)
4. 12 mL 1-Octadecylethylene (ODE)
5. 1.2 mL 1M Selenium in TOP (TOP/Se, 1.2 mmol)

Materials 1-4 were placed in a 50 mL three-neck flask equipped with thermometer sensor. After degassing/purging with nitrogen gas for 3 times, the mixture was heated to 300° C. with stirring, until a clear and colorless solution formed. 5 was then swiftly injected into the hot reaction mixture, and the reaction was left running for 30 minutes (from the start of the injection), before the heater was removed. The reaction mixture was further stirred until it reaches room temperature. Light yellow-green quantum dots (with no UV lamp) were obtained.

### Preparation of 3-Component CdSe/CdSeA/CdA (cf. FIG. 2)

In this approach a IIB cation-providing material (e.g., CdO, CdAc₂ and CdCO₃) is firstly reacted with oleic acid in ODE to form an cadmium oleate solution. At elevated temperature (300° C. in most cases), a mixture of two TOP solutions of anion-providing materials (e.g., TOP/S and TOP/Se) in a different ratio (depending on the emission wavelength desired, e.g., more sulfur leads to shorter wavelength emission) was injected. The reaction temperature was maintained for 30 minutes, before the heater was removed and the solution was allowed to cool down to room temperature whilst vigorous stirring. A few tests suggest that the fluorescence emission can be finely tuned by simply changing the ratio of the anion-providing materials. Two examples are given below:

### EXAMPLE 3

### Preparation of CdSe/CdSₓSe₁₋ₓ/CdS (Cd:S:Se=1:0.45:0.45)

Materials:
1. 0.128 g Cadmium Oxide (CdO, 1.0 mmol)
2. 1.28 mL Oleic Acid (OA, 4.0 mmol)
3. 12 mL 1-Octadecylethylene (ODE)
4. 0.45 mL 1M Sulfur in TOP (TOP/Se, 0.45 mmol)
5. 0.45 mL 1M Selenium in TOP (TOP/Se, 0.45 mmol)

Materials 1-3 were placed in a 50 mL three-neck flask equipped with thermometer sensor. After degassing/purging with nitrogen gas for 3 times, the mixture was heated to 300° C. with stirring, until a clear and colorless solution formed. A mixture of 4 and 5 was then swiftly injected into the hot reaction mixture, and the reaction was left running for 30 minutes (from the start of the injection), before the heater was removed. The reaction mixture was further stirred until it reached room temperature. Yellow-green quantum dots (with no UV lamp) were obtained.

### EXAMPLE 4

### Preparation of CdSe/CdSₓSe₁₋ₓ/CdS (Cd:S:Se=1:0.09:0.81)

Materials:
1. 0.128 g Cadmium Oxide (CdO, 1.0 mmol)
2. 1.28 mL Oleic Acid (OA, 4.0 mmol)
3. 12 mL 1-Octadecylethylene (ODE)
4. 0.09 mL 1M Sulfur in TOP (TOP/Se, 0.45 mmol)
5. 0.81 mL 1M Selenium in TOP (TOP/Se, 0.45 mmol)

Materials 1-3 were placed in a 50 mL three-neck flask equipped with thermometer sensor. After degassing/purging with nitrogen gas for 3 times, the mixture was heated to 300° C. with stirring, until a clear and colourless solution formed. A mixture of 4 and 5 was then swiftly injected into the hot reaction mixture, and the reaction was left running for 30 minutes (from the start of the injection), before the heater was removed. The reaction mixture was further stirred until it reaches room temperature. Orange-colour quantum dots (with no UV lamp) were obtained.

### Preparation of 4-Component Cd/Se/M/A (Complex Structure Assumed)

In this approach two cation-providing materials (e.g., CdO and ZnO, CdAc₂ and ZnAc₂, CdCO₃ and ZnCO₃.2Zn(OH)₂H₂O) in different ratios (depending on the desired emission wavelength, e.g., more Zn leads to shorter wavelength emission) are firstly reacted with oleic acid in ODE to form a uniform solution of an oleate salt mixture. At elevated temperature (300° C. in most cases), a mixture of two TOP solutions of anion-providing materials (e.g., TOP/S and TOP/Se) in a different ratio (depending on the emission wavelength desired, e.g. more sulfur leads to shorter wavelength emission) was injected. The reaction temperature was maintained for 30 minutes, before the heater was removed and the solution was allowed to cool down to room temperature whilst vigorous stirring. A few tests suggest that in this case room-light excitable quantum dots can still be prepared, though the tuning of the fluorescence emission is quite complicated. An example is given below:

### EXAMPLE 5

### Preparation of CdₓSe_{y}Zn₁₋ₓS_{1-y} (Cd:Zn:S:Se=1:1:0.2:1.8)

Materials:
1. 0.013 g Cadmium Oxide (CdO, 0.1 mmol)
2 0.073 g Zinc Oxide (ZnO, 0.9 mmol)
3. 1.28 mL Oleic Acid (OA, 4.0 mmol)
4. 12 mL 1-Octadecylethylene (ODE)
5. 0.6 mL 1M Sulfur in TOP (TOP/Se, 0.6 mmol)
6. 0.6 mL 1M Selenium in TOP (TOP/Se, 0.6 mmol)

Materials 1-4 were placed in a 50 mL three-neck flask equipped with thermometer sensor. After degassing/purging with nitrogen gas for 3 times, the mixture was heated to 300° C. with stirring, until a clear and colorless solution formed. A mixture of 5 and 6 was then swiftly injected into the hot reaction mixture, and the reaction was left running for 30 minutes (from the start of the injection), before the heater was removed. The reaction mixture was further stirred until it reaches room temperature. Orange-colour quantum dots (with no UV lamp) were obtained.

### Alloying Test with 3-Component Room-Light Excitable Quantum Dots

This experiment was to test if the core-mantle-shell room-light excitable quantum dots undergo an alloying process if they are heated to a sufficiently high temperature. Alloying at high temperature will be an indication of the layered structure (core-mantle-shell) of these quantum dots. For this two different strategies are applied. In Example 6 we simply replace the non-coordinating solvent ODE with its analogue with a higher boiling point, 1-Eicosene, and hold all other materials unchanged. The reaction was conducted at 300 centigrade for 30 minutes, and followed by heating the product up to 380 degree for a couple of hours. In the second test, shown in Example 7 and 8, a TOPO/HDA combination is used as the solvent instead of ODE. The quantum dots were firstly prepared at 300 centigrade, and followed by heating at 340 degrees for 1 hour to a couple of hours, respectively. Alloying process was observed in both Example 7 and 8, but not from Example 6.

### EXAMPLE 6

### Preparation of CdSe/ZnₓCd₁₋ₓSe/ZnSe in 1-Eicosene (Zn:Cd:Se=1:1:2). An Alloying Test

Materials:
1. 0.064 g Cadmium Oxide (CdO, 0.5 mmol)
2. 0.041 g Zinc Oxide (ZnO, 0.5 mmol)
3. 1.28 mL Oleic Acid (OA, 4.0 mmol)
4. 12 mL 1-Eicosene
5. 1.2 mL 1M Selenium in TOP (TOP/Se, 1.2 mmol)

Materials 1-4 (4 is pre-warmed to melt in an oven at 70 centigrade) were placed in a 50 mL three-neck flask equipped with thermometer sensor. After degassing/purging with nitrogen gas for 3 times, the mixture was heated to 300° C. with stirring, until a clear and colorless solution formed. 5 ml were then swiftly injected into the hot reaction mixture, and the reaction was running for 30 minutes (from the start of the injection). The temperature is then raised to 340° C. for half an hour, and no obvious colour change was observed. No color change was seen even if the temperature was increased to 360° C. and 380° C. After the reaction temperature was maintained at 380° C. for 10 hrs, nothing other than some slight decomposition (possibly from the solvent) took place. The reaction mixture showed a red-color when it was cooled to room temperature.

### EXAMPLE 7

### Preparation of CdSe/ZnₓCd₁₋ₓSe/ZnSe in TOPO/HDA (Zn:Cd:Se=1:1:2). An Alloying Test

Materials:
1. 0.064 g Cadmium Oxide (CdO, 0.5 mmol)
2. 0.041 g Zinc Oxide (ZnO, 0.5 mmol)
3. 1.12 g Stearic Acid (OA, 4.0 mmol)
4. 7.70 g TOPO (20 mmol)
5. 4.80 g HDA (20 mmol)
6. 1.2 mL 1M Selenium in TOP (TOP/Se, 1.2 mmol)

Materials 1-3 were placed in a 50 mL three-neck flask equipped with thermometer sensor. After degassing/purging with nitrogen gas for 3 times, the mixture was heated to 300° C. with stirring, until a clear and colorless solution formed. Cooling down the reaction mixture to room temperature, 4 and 5 are then added to the reaction flask. After another cycle of degassing/purging with nitrogen gas, the mixture was then heated to 300° C. with stirring. At 300° C. 6 was then swiftly injected into the hot reaction mixture, and the reaction was left running for 30 minutes (from the start of the injection). 2 mL of the crude product (red-color) was taken, before the reaction temperature was raised to 340° C. for 1 hour. The final reaction mixture showed a green color when it was cooled to room temperature, indicating a change at 340° C. which possibly was an alloying process.

### EXAMPLE 8

### Preparation of CdSe/ZnₓCd₁₋ₓSe/ZnSe in TOPO/HDA (Zn:Cd:Se=9:1:10). An Alloying Test

Materials:
1. 0.013 g Cadmium Oxide (CdO, 0.1 mmol)
2. 0.073 g Zinc Oxide (ZnO, 0.9 mmol)
3. 1.12 g Stearic Acid (OA, 4.0 mmol)
4. 7.70 g TOPO (20 mmol)
5. 4.80 g HDA (20 mmol)
6. 1.2 mL 1M Selenium in TOP (TOP/Se, 1.2 mmol)

Materials 1-3 were placed in a 50 mL three-neck flask equipped with thermometer sensor. After degassing/purging with nitrogen gas for 3 times, the mixture was heated to 300° C. with stirring, until a clear and colorless solution formed. Cooling down the reaction mixture to room temperature, 4 and 5 are then added to the reaction flask. After another cycle of degassing/purging with nitrogen gas, the mixture was then heated to 300° C. with stirring. At 300° C. 6 was then swiftly injected into the hot reaction mixture, and the reaction was left running for 30 minutes (from the start of the injection). 2 mL of the crude product (green-color) was taken, before the reaction temperature was raised to 340° C. for 4 hours. The final reaction mixture showed a blue color when it was cooled to room temperature, indicating a change at 340° C. which possibly was an alloying process.

### Growth Kinetics

In order to understand more on the growth of the core-mantle-shell quantum dots and get further evidence on the proposed structure, two examples are given in which two different sets of the recipes are taken. The solutions of the aliquots from the reaction mixture at different reaction period were measured by UV-visible and photoluminescence spectroscopy.

### EXAMPLE 9

### Preparation of CdSe/ZnₓCd₁₋ₓSe/ZnSe (Zn:Cd:Se=1:1:2)

Materials:
1. 0.064 g Cadmium Oxide (CdO, 0.5 mmol)
2. 0.041 g Zinc Oxide (ZnO, 0.5 mmol)
3. 1.28 mL Oleic Acid (OA, 4.0 mmol)
4. 12 mL 1-Octadecylethylene (ODE)
5. 1.2 mL 1M Selenium in TOP (TOP/Se, 1.2 mmol)

Materials 1-4 were placed in a 50 mL three-neck flask equipped with thermometer sensor. After degassing/purging with nitrogen gas for 3 times, the mixture was heated to 300° C. with stirring, until a clear and colorless solution formed. 5 was then swiftly injected into the hot reaction mixture, and aliquots of the reaction mixture was taken at the 1^{st}, 2^{nd}, 3^{rd}, 4^{th}, 5^{th}, 10^{th}, 15^{th}, 20^{th}, 25^{th}, 30^{th}, 60^{th}, 120^{th} and 240^{th} min, respectively, and quenched with cold n-hexane solution immediately. UV-visible and photoluminescence spectra are taken from the diluted n-hexane solution of these samples. The results are shown below.

### EXAMPLE 10

### Preparation of CdSe/ZnₓCd₁₋ₓSe/ZnSe (Zn:Cd:Se=9:1:10)

Materials:
1. 0.013 g Cadmium Oxide (CdO, 0.1 mmol)
2. 0.073 g Zinc Oxide (ZnO, 0.9 mmol)
3. 1.28 mL Oleic Acid (OA, 4.0 mmol)
4. 12 mL 1-Octadecylethylene (ODE)
5. 1.2 mL 1M Selenium in TOP (TOP/Se, 1.2 mmol)

Materials 1-4 were placed in a 50 mL three-neck flask equipped with thermometer sensor. After degassing/purging with nitrogen gas for 3 times, the mixture was heated to 300° C. with stirring, until a clear and colorless solution formed. 5 was then swiftly injected into the hot reaction mixture, and aliquots of the reaction mixture was taken at the 5^{th}, 20^{th}, 40^{th} second and 4^{th}, 8^{th}, 16^{th}, 32^{th}, and 128^{th} min, respectively, and quenched with cold n-hexane solution immediately. UV-visible and photo-luminescence spectra are taken from the diluted n-hexane solution of these samples. The results are shown below.

### Comparison of Stearic Acid and Oleic Acid

Stearic acid with a lower cost can be an alternative for oleic acid (especially for mass industrial production), if such replacement does not compromise the quality of the prepared quantum dots. The test below was to find out, if the replacement would lead to any apparent difference in the final quantum dot product.

### EXAMPLE 11

### Preparation of CdSe/ZnₓCd₁₋ₓSe/ZnSe (Zn:Cd:Se=1:1:2), Using Stearic Acid

Materials:
1. 0.064 g Cadmium Oxide (CdO, 0.5 mmol)
2. 0.041 g Zinc Oxide (ZnO, 0.5 mmol)
3. 1.13 g Stearic Acid (OA, 4.0 mmol)
4. 12 mL 1-Octadecylethylene (ODE)
5. 1.2 mL 1M Selenium in TOP (TOP/Se, 1.2 mmol)

Materials 1-4 were placed in a 50 mL three-neck flask equipped with thermometer sensor. After degassing/purging with nitrogen gas for 3 times, the mixture was heated to 300° C. with stirring, until a clear and colourless solution formed. 5 was then swiftly injected into the hot reaction mixture, and the reaction was left running for 30 minutes (from the start of the injection), before the heater was removed. The reaction mixture was further stirred until it reaches room temperature. Room-light excitable quantum dots are obtained, indicating that stearic acid is indeed a qualified alternative for oleic acid.

### Preparation at Ambient Condition without Degassing/Purging with N₂ Gas

One further test is to see if air or moisture has any pronounced effect on the preparation of the quantum dots, i.e. if the degassing/purging with nitrogen is a necessity. This is also a test needed for mass production, if cost of preparation is considered.

### EXAMPLE 12

### Preparation of CdSe/ZnₓCd₁₋ₓSe/ZnSe (Zn:Cd:Se=1:1:2)—No Nitrogen Purge

Materials:
1. 0.064 g Cadmium Oxide (CdO, 0.5 mmol)
2. 0.041 g Zinc Oxide (ZnO, 0.5 mmol)
3. 1.28 mL Oleic Acid (OA, 4.0 mmol)
4. 12 mL 1-Octadecylethylene (ODE)
5. 1.2 mL 1M Selenium in TOP (TOP/Se, 1.2 mmol)

Materials 1-4 were placed in a 50 mL three-neck flask equipped with thermometer sensor. Without degassing/purging with nitrogen, the mixture was heated to 300° C. with stirring. After ˜10 min, a clear and colorless solution formed. 5 was then swiftly injected into the hot reaction mixture, and the reaction was left running for 30 minutes (from the start of the injection), before the heater was removed. The reaction mixture was further stirred until it reaches room temperature. Shining bright-red quantum dots (with no UV lamp) were obtained, indicating that the quantum dots can also be directly prepared at ambient condition in the presence of small amounts of air and moisture.

### Scale-Up Test

With the success of preparing quantum dots in open-air system (in the presence of natural air and moisture) in hundreds of milligram production, our interest is extended to produce a few grams of quantum dots in a single batch. For this, a scale-up test is conducted, as shown in Example 13 below.

### EXAMPLE 13

### Scale-Up Preparation of CdSe/ZnₓCd₁₋ₓSe/ZnSe (Zn:Cd:Se=1:1:2)

Materials:
1. 3.20 g Cadmium Oxide (CdO, 25 mmol)
2. 2.04 g Zinc Oxide (ZnO, 25 mmol)
3. 64 mL Oleic Acid (OA, 200 mmol)
4. 120 mL 1-Octadecylethylene (ODE)
5. 60 mL 1M Selenium in TOP (TOP/Se, 60 mmol)

Materials 1-5 were placed in a 500 mL three-neck flask equipped with a condenser on a water-splitter. The use of a device or method that is capable of removing water from the system is highly recommended, since the water generated in the reaction may cause explosive boiling or related phenomenon when droplets fall back into the hot reaction mixture. It is noted that such explosive boiling can be avoided if zinc and cadmium oleate are prepared in advance. The mixture was heated to boiling with stirring, and left running at boiling point for 30 minutes, before it was cooled down to room temperature naturally with stirring. Bright red quantum dots were obtained. In spite of not dissolving the oxides before the reaction starts, the experiment shows that the scale-up reaction works. The product yield, including the ligand shell weight, is ˜8.0 gram.

### Ligand Exchange Reaction

The ligand shell of the as-prepared quantum dots, the oleate, can be converted to shell with desired functional groups via ligand exchange reaction. Crude quantum dots may be directly used for ligand exchange reaction if the resulting quantum dots are insoluble in non-water solvents, e.g., chloroform. In this case all impurities can be simply washed away from the products. For the case that the hydrophobic nature of the quantum dots is retained after the ligand exchange, a purification of the quantum dots is necessary. A general procedure is as followings:

0.5 mL of the crude quantum dot product is loaded in 2 mL of toluene in a centrifugation tube. After a short vortexing, 8 mL of methanol is added. Further vortexing leads to a cloudy solution, which gives color pellet at the bottom of the tube after centrifugation at 10000 rpm for 10 minutes. The top solution is then decanted, and the whole process repeated with the pellet at the bottom. The resulting pellet in the 2^{nd} run is then dispersed in chloroform for ligand exchange reaction with thiols or their solution.

The ligand exchange reaction for these quantum dots is quite simple. An example given in the following is the preparation of water-soluble —COOH terminated quantum dots. In a centrifugation tube with 5 mL of quantum dots chloroform solution, 0.5 mL of thioglycolic acid (excess amount) is added. After shaking, the solution becomes cloudy. After a 5-min sonicating, the product is collected by centrifugation at 10000 rpm for 5 minutes. Removing the upper colorless solution, the pellet is washed by chloroform 2 times, and collected via centrifugation each time. The resulted pellet can be directly dispersed in water or PBS buffer.

### 2. Results

In this part we show some results taken from the tests conducted in part 3, and try to interpret the promising optical properties from the quantum dots with a novel core-mantle-shell structure.

### 2.1 General Comparison

Compared to the conventional method for the preparation of core-shell quantum dots, a process according to the present invention is much simpler and the products possess better optical properties. A detailed comparison between the two approaches is shown in Table I.

### 2.2 Visible Light Excitable Fluorescence

As described above, a novel feature of the quantum dots prepared in this invention is room-light excitable fluorescence, i.e. the quantum dots display a fluorescent color in the absence of a formal excitation light source. One of images taken on a number of such quantum dots by a digital camera in weak room light is shown in FIG. 6A. From left to right, the initial concentration of the zinc salt decreases steadily with the total concentration of zinc and cadmium oleate being a constant. By this the photoluminescence emission wavelength gradually red-shifts from yellow-green to near infra-red. This might be due to with a lower zinc salt concentration the formation of the ZnSe shell starts at a later stage (smaller reaction rate), which allows for the growth of CdSe to a later stage (a larger size) thus causing a red-shift in the emission wavelength. The fluorescence seems much weaker for the two samples to the right in FIG. 6A. There might be two reasons for such a visual difference: 1) the emission wavelengths for the right two samples are much closer to the near infrared (667 nm and 689 nm), and our visual sensors are not sensitive to these wavelengths; 2) Their absorption bands cover all the visible light wavelength range, giving a color resembling the black color, in which all visible light is absorbed. Thus, they seem not fluorescent in room-light.

Once a UV lamp is switched on to excite these quantum dots, strong fluorescence is immediately seen (FIG. 6B). The three samples on the left side even show a saturated brightness resembling a bright-white emitting, indicating a high quantum yield and low self-absorption (at high concentration). The low self-absorption is also a key factor enabling the room-light excitable property, which makes them different from conventional quantum dots in high concentration solutions.

The low absorption feature becomes clearly apparent if the UV-visible absorption spectra of quantum dots obtained by the process according to the present invention are compared to those of some conventional quantum dots. An example is shown above in FIG. 7, in which both quantum dot samples have very similar photoluminescence spectra while their absorbance was normalized for comparison. Those peaks ranging from 650 nm to 450 nm for the conventional quantum dots are either lower or disappeared for the room-light excitable quantum dots. Another observation from FIG. 7 is that the first absorption peak of the room-light excitable quantum dots lies at a slightly longer wavelength position than that of the conventional ones, indicating a smaller Stock shift, which is believed as a consequence of improved crystal quality (especially the quantum dots surface).

### 2.3 Tunable Fluorescence Via Variation in the Ratio of the Starting Materials

The fluorescence emission wavelength of the room-light excitable quantum dots can be simply tuned by varying the ratio of the starting materials in the preparation reaction while holding all other reaction parameters unchanged. The ratio of Cd/Zn in the reaction ranges from 1:19 to 9:1, leading to an emission wavelength of λ=528 nm to λ=689 nm. The reaction is reproducible with small deviations in the emission wavelength position, if the reaction condition and the operations in the reaction are carefully repeated. Fluorescence spectra from some of the room-light excitable quantum dots are shown in FIG. 8.

One can see that besides the tuneable wavelength of the emission peak for Δλ>160 nm, the emission peak is getting narrower at shorter wavelengths. At the emission of λ˜560 nm the full width at the half maximum for the spectrum is as small as 19 nm, which is better than any core-shell quantum dots reported so far.

The elemental analysis on the room-light excitable quantum dots via Inductively Coupled Plasma Mass Spectrometry (PSB, Singapore) shows that the composition of the resultant quantum dots are almost as same as what was input in the starting materials (Zn/Cd, w/w: 2.84/5.38, corresponding to a molar ratio of 0.91:1 for a starting ratio of 1:1; w/w: 4.43/0.85, corresponding to a molar ratio of 8.96:1 for a starting ratio of 9:1), which is very different from what was reported in alloy quantum dots preparation (X. Zhong, et al., J. Am. Chem. Soc. 2003, 125, 8589; X. Zhong, et al., J. Am. Chem. Soc. 2003, 125, 13539). The emission peaks of the room-light excitable quantum dots are in much longer wavelengths if they are compared to those alloy quantum dots with similar composition. This suggests a core-shell structure for the room-light excitable quantum dots prepared here.

### 2.4 Further Evidence for Core-Mantle-Shell Structure

In order to further prove the core-mantle-shell structure, similar reactions (cf. Section 3.4) were conducted in 1-Eicosene, or in tri-n-octyl phosphine oxide (TOPO) in the presence of n-hexadecylamine (HDA) (easy for alloying process) with different Zn/Cd ratio, respectively. In 1-Eicosene no alloying process takes place, even if the reaction mixture was heated to 380° C. and kept at the temperature for 10 hours after the core-mantle-shell quantum dots formed at 300° C. This suggests that the core-shell-mantle quantum dots possess extremely good thermal stabilities.

When the combination of TOPO/HDA was used, with similar amount of starting materials, at the same temperature and with the same reaction period, room-light excitable quantum dots with emissions at similar wavelength are obtained, though the peaks are much broader (see broken lines in FIG. 10; different colours denote two recipes with different ratios of staring materials). This suggests that quantum dots with similar structure formed, though this solvent combination is not good for the preparation of such quantum dots. As the temperature was increased to 340° C. and kept at the same temperature for 1 hour to a few hours (cf. Section 3.4), the peaks of the emission spectra dramatically shifted to the shorter wavelength with a Δλ of 80˜100 nm (see corresponding solid lines in FIG. 10) and the emission spectra were greatly narrowed down. These two new spectra resemble those of alloy quantum dots. The two counterparts before the alloying process thus possess a core-mantle-shell structure.

Further evidence for the core-mantle-shell structure is provided by the kinetics of their preparation reactions. Given in FIG. 5 are two examples with different ratios of the starting materials (Section 3.5). With a higher initial concentration of the zinc salts the CdSe cores formed at the beginning of the reaction are small (FIG. 5A, PL˜532 nm). Despite the adsorption of the zinc salts species the core grows to a size corresponding to an emission of ˜580 nm. Further heating induces a blue-shift in the emission which is understood as the alloying process at the interface of CdSe and ZnSe, leading to the formation of a mantle layer and thus a smaller core size with shorter emission wavelength. The alloying process, however, is invisible if the initial concentration of zinc salts is one order of magnitude lower (FIG. 5B). This is very probably due to the difference in the melting point between CdSe of different size (for lower zinc salt concentration the CdSe core size is larger). Alloy formation requires some kind of melting process which allows for the penetration of alternative cations or anions to replace the existing counterparts. The reaction temperature applied here, may exceed the melting point of the CdSe nuclei formed at higher zinc salt concentration while is lower than that of the CdSe quantum dots formed at lower zinc salt concentration (melting point of nanocrystals decreases if their size becomes smaller). The more interesting feature of this synthetic approach, as seen from both cases in FIG. 5, is that regardless how poorly the reaction started, the products always arrive at a well-defined product state, i.e., a high quantum yield with a relatively narrow full width at half maximum (FWHM), a criterion for the quality of quantum dots.

### 2.5 XRD Patterns for Room-Light Excitable Quantum Dots

More evidence for the core-mantle-shell structure is the X-ray diffraction (XRD) patterns of the room-light excitable quantum dots. Core-mantle-shell quantum dots with different starting Zn/Cd ratios (19:1 to 1:9) were purified and prepared as thin drop-casting films on Si(100) substrates for XRD measurements. The XRD patterns of these quantum dots are shown together with those of cadmium selenide (bottom) and zinc selenide quantum dots (top) in FIG. 9.

One can see that with a smaller lattice parameter the diffraction peaks for zinc selenide (ZnSe, topmost) quantum dots lie at higher angular positions comparing to those for cadmium selenide (CdSe, bottommost) quantum dots. The room-light excitable quantum dots prepared in this invention show the same patterns (Wurzite structure) and the angular positions of the diffraction peaks just lie in between the two. As the amount of ZnSe in the room-light excitable quantum dots increases gradually (corresponding to an increase in the shell thickness), the diffraction patterns shift steadily to higher angular positions. The Wurtzite strutucre of these quantum dots resemble the most common structure of CdSe quantum dots. This can be understood because CdSe cores form first which decides the crystal structure and the ZnSe follow the same atom orientation (to enable the lattice match) and grow as shells.

For 3-component CdSe/CdSeA/CdA quantum dots, e.g., CdSe/CdSeₓS₁₋ₓ/CdS, with Cd being the common species shared by S and Se, the situation is changed. The products prepared in this case show strong photoluminescence, however, their crystal structure is no longer Wurtzite (common for CdSe), but the Zinc Blende (common for CdS), as shown in FIG. 14. If one holds that CdS nuclei form first (to define the crystal type for growth) and a core-shell structure exists, the shell will be CdSe which is fragile to surface modification, especially for water-solubilisation. The robust ligand exchange with thioglycolic acid (per tests) excludes the possibility of a CdSe shell. Moreover, if CdS was the core in the core-mantle-shell structure, the maximum emission (except the band-edge emission with low intensity) will be ˜480 nm. This simply contradicts with the experiment results, in which the products prepared can have emission peaks above 600 nm. Long wavelength emission also excludes the existence of the CdSₓSe₁₋ₓ as the emitting core, which is most likely in the blue light wavelength range. All these facts point to the conclusion that the emission centers in the products are most probably still CdSe, which, in the presence of the sulfur, formed a Zinc Blende structure with a core-mantle-shell structure. It was found that the fluorescence of the quantum dots is also tuneable via changes in the ratio of S/Se in the solution injected into the flask. As the amount of sulfur increases, the diffraction peaks shift to higher angular positions (red broken line in FIG. 14).

If transmission electronic microscope images are taken from the quantum dots, it is found that all the CdSe/CdₓZn₁₋ₓSe/ZnSe room-light excitable nanocrystals are dot-shape. An example is given in FIG. 12A. The monodispersity of these quantum dots is satisfactory, accounting for the narrow fluorescence emission peaks shown in FIG. 8. For CdSe/CdSeₓS₁₋ₓ/CdS, the nanocrystals obtained are more or less a rod structure with a low aspect ratio (less than 2), as shown in FIG. 12B. The formation of such anisotropic shape mainly related to the difference in the energy of different faces of the nanocrystals during the reaction. However, for nanocrystals with a Zinc Blende structure, the energy for all 6 surfaces should be quite similar, which is not sufficient to explain the anisotropic growth. Moreover, with the increased amount of sulfur, the XRD pattern is no longer pure Zinc Blende (a shoulder peak at ˜30 degree for the red broken line of FIG. 14). Together with the rod-shape it implies that a more complicated growth mechanism is involved in the formation of the CdSe/CdSeₓS₁₋ₓ/CdS nanocrystals.

For the four-component nanocrystals, prepared from the reaction of two cations (Cd²⁺ and Zn²⁺) with two anions (S²⁻ and Se²⁻), the shape of a flower is observed, if a certain ratio between Cd/Zn and S/Se is used. FIG. 13 shows images of such product at different magnifications. With a diameter larger than 20 nm, these crystals still show strong fluorescence.

The listing or discussion of a previously published document in this specification should not necessarily be taken as an acknowledgement that the document is part of the state of the art or is common general knowledge. All documents listed are hereby incorporated herein by reference in their entirety for all purposes as if each individual document were specifically and individually indicated to be incorporated by reference.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

The invention illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognised that various modifications are possible within the scope of the invention claimed. Additional objects, advantages, and features of this invention will become apparent to those skilled in the art upon examination of the foregoing examples and the appended claims. Thus, it should be understood that although the present invention is specifically disclosed by exemplary embodiments and optional features, modification and variation of the inventions embodied therein herein disclosed may be resorted to by those skilled in the art, and that such modifications and variations are considered to be within the scope of this invention. In addition, where features or aspects of the invention are described in terms of Markush groups, those skilled in the art will recognise that the invention is also thereby described in terms of any individual member or subgroup of members of the Markush group.

1.-40. (canceled)

41. A process of forming a Cd and Se containing nanocrystalline composite being composed of the elements Cd, M, and Se, the nanocrystalline composite being of a composite structure in that it is non-homogenous,
wherein M is an element of group 12 of the PSE other than Cd,
the process comprising:
(i) forming in a suitable solvent a solution of the element Cd or a Cd precursor, and of M, or a precursor thereof, without removing oxygen, wherein the solvent is amine free,
(ii) adding to the solution the element Se, thereby forming a reaction mixture,
(iii) heating the reaction mixture for a sufficient period of time at a temperature suitable for forming the Cd and Se containing nanocrystalline composite and then allowing the reaction mixture to cool,
(iv) isolating the Cd and Se containing nanocrystalline composite of a composite structure,
wherein the term “amine free” means the complete absence of an amine from the solvent.

42. A process of forming a Cd and Se containing nanocrystalline composite being composed of the elements Cd, M, Se, and A, the nanocrystalline composite being of a composite structure in that it is non-homogenous,
wherein M is an element of group 12 of the PSE other than Cd, and A is an element of group 16 of the PSE other than O and Se,
the process comprising:
(i) forming in a suitable solvent a solution of the element Cd or a Cd precursor, and of M, or a precursor thereof, without removing oxygen, wherein the solvent is amine free,
(ii) adding to the solution the element Se and A, thereby forming a reaction mixture,
(iii) heating the reaction mixture for a sufficient period of time at a temperature suitable for forming the Cd and Se containing nanocrystalline composite and then allowing the reaction mixture to cool,
(iv) isolating the Cd and Se containing nanocrystalline composite of a composite structure,
wherein the term “amine free” means the complete absence of an amine from the solvent.

43. The process of claim 42, wherein forming the solution of the element Cd, or a Cd precursor, and of M, or a precursor thereof, comprises adding said components into a suitable solvent and heating the same.

44. The process of claim 43, wherein the solvent is heated to a temperature from about 100° C. to about 400° C.

45. A process of forming a Cd and Se containing nanocrystalline composite being composed of the elements Cd, Se and A, the nanocrystalline composite being of a composite structure in that it is non-homogenous,
wherein A is an element of group 16 of the PSE other than O and Se,
the process comprising:
(i) forming in a suitable solvent a solution of the element Cd or a Cd precursor, wherein the solvent is amine free, without removing oxygen,
(ii) adding to the solution the element Se and A, thereby forming a reaction mixture,
(iii) heating the reaction mixture for a sufficient period of time at a temperature suitable for forming the Cd and Se containing nanocrystalline composite and then allowing the reaction mixture to cool,
(iv) isolating the Cd and Se containing nanocrystalline composite of a composite structure,
wherein the term “amine free” means the complete absence of an amine from the solvent.

46. The process of claim 45, wherein forming the solution of the element Cd or a Cd precursor, comprises adding the element Cd or the Cd precursor, into a suitable solvent and heating the same.

47. The process of claim 46, wherein the solvent is heated to a temperature from about 100° C. to about 400° C.

48. The process of claim 41, wherein the element Se is added by injection.

49. The process of claim 42, wherein A and the element Se are added together.

50. A process of forming a Cd and Se containing nanocrystalline composite having a composition of one of (a) Cd, M, Se, (b) Cd, Se, A, and (c) Cd, M, Se, A
wherein M is an element of group 12 of the PSE other than Cd,
A is an element of group 16 of the PSE other than O and Se,
the nanocrystalline composite being of a composite structure in that it is non-homogenous,
the process comprising:
(i) adding into a suitable solvent the element Cd or a Cd precursor, without removing oxygen, wherein the solvent is amine free,
adding the element Se, in the formation of a nanocrystalline composite having a composition of (a) Cd, M, Se, or (c) Cd, M, Se, A, adding M, or a precursor thereof, and, in the formation of a nanocrystalline composite having a composition of (b) Cd, Se, A, or (c) Cd, M, Se, A, adding A, thereby forming a reaction mixture,
(ii) heating for a sufficient period of time the reaction mixture at a temperature suitable for forming the Cd and Se containing nanocrystalline composite, wherein heating further comprises removing water formed in the reaction mixture, and then allowing the reaction mixture to cool,
(iii) isolating the Cd and Se containing nanocrystalline composite of a composite structure,
wherein the term “amine free” means the complete absence of an amine from the solvent.

51. The process of claim 41, wherein the solvent comprises a coordinating compound.

52. The process of claim 41, wherein the cadmium precursor is formed from an inorganic cadmium compound.

53. The process of claim 41, wherein the precursor of M is formed from an inorganic compound thereof.

54. The process of claim 41 in the formation of a nanocrystalline composite having a composition of one of (a) Cd, M, Se, or (c) Cd, M, Se, A, wherein (i) Cd, or the Cd precursor, and (ii) M, or the precursor thereof, are used in a predefined molar ratio, the predefined molar ratio of Cd, or Cd precursor : M, or precursor of M being selected in the range from about 1:100 to about 100:1.

55. The process of claim 54, wherein the predefined molar ratio of Cd, or Cd precursor:M, or precursor of M is selected in the range from about 1:10 to about 10:1.

56. The process of claim 55 in the formation of a nanocrystalline composite having a composition of (b) Cd, Se, A, or (c) Cd, M, Se, A, wherein A and Se are used in a predefined molar ratio, the predefined molar ratio of A:Se being selected in the range a ratio from about 1:100 to about 100:1.

57. The process of claim 56, wherein A and Se are used in a ratio from about 1:10 to about 10:1.

58. The process of claim 41, wherein (i) Cd or the Cd precursor and (ii) Se are used in a predefined molar ratio, the predefined molar ratio of of Cd, or Cd precursor:Se being selected in the range from about 1:100 to about 100:1.

59. The process of claim 41 in the formation of a nanocrystalline composite having a composition of (a) Cd, M, Se or (c) Cd, M, Se, A, wherein M, or the precursor thereof, and Se are used in a predefined molar ratio, the predefined molar ratio of M, or M precursor:Se being selected in the range from about 1:100 to about 100:1.

60. The process of claim 59, wherein M, or the precursor thereof, and Se are used in a ratio from about 1:10 to about 10:1.

61. The process of claim 41, wherein M is the element Zn.

62. The process of claim 41, wherein A is one of the elements S and Te.

63. A Cd and Se containing nanocrystalline composite having a composition of one of (a) Cd, M, Se, (b) Cd, Se, A, and (c) Cd, M, Se, A, wherein M is an element of group 12 of the PSE other than Cd, and A is an element of group 16 of the PSE other than O and Se, wherein the nanocrystalline composite is of a composite structure, wherein the nanocrystalline composite is of a composite structure in that it is non-homogenous, the nanocrystalline composite being obtainable by the process of claim 41.
